(19) United States
(12) Patent Application Publication
(10) Pub. No.: US 2014/0127503 A1
(43) Pub. Date: May 8, 2014

(54) MULTI-LAYERED PRESSURE-SENSITIVE ADHESIVE ARTICLE AND PRESSURE-SENSITIVE ADHESIVE SHEET

(71) Applicants: Mitsuyoshi Shirai, Ibaraki-shi (JP); Eriko Funatsu, Ibaraki-shi (JP); Hidetoshi Maikawa, Ibaraki-shi (JP)

(72) Inventors: Mitsuyoshi Shirai, Ibaraki-shi (JP); Eriko Funatsu, Ibaraki-shi (JP); Hidetoshi Maikawa, Ibaraki-shi (JP)

(73) Assignee: NITTO DENKO CORPORATION, Ibaraki-shi, Osaka (JP)

(21) Appl. No.: 14/130,108

(22) PCT Filed: May 29, 2012
(86) PCT No.: PCT/JP2012/063786

§ 371 Date: Dec. 30, 2013

(30) Foreign Application Priority Data
Jul. 1, 2011 (JP) 2011-147390
Jul. 1, 2011 (JP) 2011-147445

(51) Int. Cl. C09J 7/02

(52) U.S. Cl. CPC C09J 7/0217
USPC 428/354

(57) ABSTRACT

The present invention provides a multi-layered PSA article having higher interlayer adhesive strength. The multi-layered PSA article of the present invention comprises a PSA layer (A) formed from a PSA composition (a) comprising an acrylic polymer (a) as a primary component, a PSA layer (B) formed from a PSA composition (b) comprising an acrylic polymer (b) as a primary component, and an intermediate layer (C) placed between the PSA layer (A) and the PSA layer (B), wherein the PSA composition (a) and the PSA composition (b) individually further comprise a compound having per molecule two or more functional groups that are capable of reacting with active hydrogen, and the intermediate layer (C) is formed from an intermediate layer composition (c) comprising a polymer (c) obtained by polymerizing a monomer composition (c) comprising a monomer having an active hydrogen.

### TECHNICAL FIELD

The present invention relates to a multi-layered pressure-sensitive adhesive (PSA) article as well as a PSA sheet obtained by forming the multi-layered PSA article into a sheet. The present application claims priority to Japanese Patent Application No. 2011-147390 filed on Jul. 1, 2011 and Japanese Patent Application No. 2011-147445 filed on Jul. 1, 2011, and the entire contents of these applications are incorporated herein by reference.

### BACKGROUND ART

PSA tapes such as double-faced tapes has been conventionally required to combine conflicting properties such as high wettability to adherends, adhesiveness, high cohesive strength, and so on. In addition, when adhered to two types of adherend having different surface properties, PSA formed from the same composition is unlikely to exhibit good adhesive properties to both of the two adherends. This has been often handled by achieving a balance midway between the two in terms of the properties.

For improvement in such aspects, there have been experiments to use two or more PSA species having different compositions to form multi-layered constitutions, such as, in order to increase the adhesion and anchoring relative to different adherends or supports, or in order to vary the compositions and physical properties among the surface layers of which strong bonding to adherends is required and the inner layers of which high cohesive strength is required, thereby controlling the properties.

For example, Patent Document 1 discloses a PSA tape comprising an adhesive layer having a multi-layered constitution formed from two or more types of compositions differed in the shear creep compliance. This tape is reported to be useful especially as diaper tape and labels for fabrics that are intended for adherends having irregular surfaces and are to experience various external stresses applied thereto when in use.

However, a PSA tape comprising an adhesive layer having a multi-layered constitution as described above has drawbacks such as weak interlayer bonding strength and likelihood of delamination under external stresses such as shear forces, etc.

In order to solve such problems, a PSA tape that has been suggested consists of multiple laminated layers with at least one of the external layers being a PSA layer, wherein adjacent layers have interfaces formed between the adjacent layers with each of these layers being formed with a photopolymerized polymer chain matrix, wherein the presences of polymer chains extend from a matrix in these layers via the interfaces into the adjacent layers with the polymer chains being formed of polymerized monomers that had migrated from the matrices of the respective adjacent layers prior to the polymerization while these layers cannot be delaminated (see Patent Document 2).

There has been also suggested a production method for a PSA tape, where at least two types of adhesive layers obtained by photopolymerizing compositions each containing an alkyl (meth)acrylate and a photopolymerization initiator are laminated so that adjacent layers have different compositions, and the adjacent layers are then chemically bonded to each other by reaction between a reactive functional group incorporated into the molecule of the alkyl (meth)acrylate polymer constituting one of the adjacent layers and an active hydrogen-containing functional group incorporated into the molecule of the alkyl (meth)acrylate polymer constituting the other layer (see Patent Document 3).

### CITATION LIST

### Patent Literature

[Patent Document 1] Japanese Patent Application Publication No. S54-139946
[Patent Document 2] Japanese Examined Patent Application Publication No. H2-6790
[Patent Document 3] Japanese Patent Application Publication No. H5-105851

### SUMMARY OF INVENTION

### Technical Problem

However, there has been a demand for a PSA tape having higher interlayer adhesive strength than the PSA tapes according to Patent Documents 1 to 3.

An objective of the present invention is to provide a multi-layered PSA article having higher interlayer adhesive strength.

### Solution to Problem

The present inventors have earnestly researched for a solution to the problems. As a result, it has been discovered that higher interlayer adhesion is obtained when a multi-layered PSA article is fabricated by forming an intermediate layer between two PSA layers from a composition comprising a polymer obtained by polymerizing a monomer composition containing a monomer having an active hydrogen, with the PSA layers each containing a compound having two or more functional groups that are capable of reacting with active hydrogen, whereby the present invention has been completed.

In particular, the multi-layered PSA article according to the present invention is characterized by comprising a PSA layer (A) formed from a PSA composition (a) comprising an acrylic polymer (a) as a primary component, a PSA layer (B) formed from a PSA composition (b) comprising an acrylic polymer (b) as a primary component, and an intermediate layer (C) placed between the PSA layer (A) and the PSA layer (B), wherein the PSA composition (a) and the PSA composition (b) individually further comprise a compound having per molecule two or more functional groups that are capable of reacting with active hydrogen, and the intermediate layer (C) is formed from an intermediate layer composition (c) comprising a polymer (c) obtained by polymerizing a monomer composition (c) comprising a monomer having an active hydrogen.

In the multi-layered PSA article according to the present invention, the monomer having the active hydrogen preferably comprises one or more species of functional group selected from a group consisting of carboxyl group, hydroxyl group and amino groups.

In the multi-layered PSA article according to the present invention, it is preferable that the acrylic polymer (a) is obtainable by polymerizing a monomer composition (a), the acrylic polymer (b) is obtainable by polymerizing a monomer composition (b), and the monomer composition (c) comprises a primary monomer of the monomer composition (a) and a primary monomer of the monomer composition (b).

In the multi-layered PSA article according to the present invention, the monomer composition (c) preferably comprises all monomers contained in the monomer composition (a) and all monomers contained in the monomer composition (b).

In the multi-layered PSA article according to the present invention, the compounds contained in the PSA composition (a) and the PSA composition (b), with each having per molecule two or more functional groups that are capable of reacting with active hydrogen, are preferably polyfunctional isocyanate compounds.

In the multi-layered PSA article according to the present invention, the monomer having the active hydrogen is preferably a monomer comprising a hydroxyl group.

In the multi-layered PSA article according to the present invention, the monomer having the active hydrogen is preferably a monomer comprising an amino group.

In the multi-layered PSA article according to the present invention, it is preferable that the intermediate layer (C) further comprises one or more species selected from a group consisting of a polymer (c-a) obtained by polymerizing a monomer composition (c-a) and a polymer (c-b) obtained by polymerizing a monomer composition (c-b), wherein the monomer composition (c-a) comprises the monomer having the active hydrogen and a primary monomer of the monomer composition (a) while the monomer composition (c-b) comprises the monomer having the active hydrogen and a primary monomer of the monomer composition (b).

In the multi-layered PSA article according to the present invention, it is preferable that at least one species selected from a group consisting of the acrylic polymer (a) and the acrylic polymer (b) comprises an acid group while the polymer (c) comprises a primary to tertiary amino group.

In the multi-layered PSA article according to the present invention, it is preferable that at least one species selected from a group consisting of the acrylic polymer (a) and the acrylic polymer (b) comprises an acid group while at least one species selected from a group consisting of the polymer (c), the polymer (c-a) and the polymer (c-b) comprises a primary to tertiary amino group.

The PSA sheet according to the present invention is characterized by comprising, as a PSA layer, a multi-layered PSA article according to the present invention described above.

### Advantageous Effects of Invention

The multi-layered PSA article according to the present invention has the constitution described above, thus a multi-layered PSA article having higher interlayer adhesive strength can be provided. In particular, a multi-layered PSA article capable of suppressing interlayer delamination upon removal, etc., can be provided.

### DESCRIPTION OF EMBODIMENTS

The present description includes at least a first invention described next and a second invention described later. The first invention (or simply “the present invention” until the description of the second invention, hereinafter) is described in detail next.

It is noted that “A to B” indicating a range means “A or greater, but B or smaller” and various physical properties given in the present description refer to values measured by the methods described in Examples described later unless otherwise noted. In the present description, “(meth)acryl” in “(meth)acrylic acid” and the like term means “acryl and/or methacryl”.

The “primary component” in the present description refers to a component that accounts for the highest content by weight of a given composition.

### (I) Multi-Layered PSA Article

The multi-layered PSA article according to the present invention comprises a PSA layer (A) formed from a PSA composition (a) comprising an acrylic polymer (a) as a primary component, a PSA layer (B) formed from a PSA composition (b) comprising an acrylic polymer (b) as a primary component, and an intermediate layer (C) placed between the PSA layer (A) and the PSA layer (B), wherein the PSA composition (a) and the PSA composition (b) individually further comprise a compound having per molecule two or more functional groups that are capable of reacting with active hydrogen, and the intermediate layer (C) is formed from an intermediate layer composition (c) comprising a polymer (c) obtained by polymerizing a monomer composition (c) comprising a monomer having an active hydrogen.

It is considered that according to the embodiment, the polymer (c) having an active hydrogen in the intermediate layer (C) forms covalent bonds or interacts with the compounds having per molecule two or more functional groups that are capable of reacting with active hydrogen (or “active-hydrogen-reactive polyfunctional compound” hereinafter) in the PSA layer (A) and the PSA layer (B); and therefore, the interlayer adhesive strength increases. Since the embodiment can be fabricated by a polymerization method other than photopolymerization, its production is less limited.

In general, in production methods for acrylic polymers involving photopolymerization such as UV polymerization, etc., the production rate is lower than those in solvent systems and emulsion systems. Since the polymerization would not proceed unless the system is blocked from the air, air blocking is necessary prior to photoirradiation. Thus, there are limitations such as costing more due to these aspects, etc.

### (I) PSA Layer (A)

The PSA layer (A) can be formed from a PSA composition (a) comprising an acrylic polymer (a) as the primary component.

<Acrylic Polymer (a)>

The acrylic polymer (a) is obtainable by polymerizing a monomer composition (a) comprising an alkyl (meth)acrylate as a primary component. If desired, the monomer composition (a) may contain an unsaturated monomer that is polymerizable with the alkyl (meth)acrylate.

Examples of the alkyl (meth)acrylate include alkyl (meth)acrylates containing an alkyl group having 1 to 18 carbon atoms, in particular, compounds represented by the following general formula (1).

[Chem 1]

H₂C═CR¹COOR² (1)

(in general formula (1), R¹ is a hydrogen atom or a methyl group and R² is a linear or branched alkyl group having 1 to 18 carbon atoms.)

Specific examples of R² in general formula (1) include methyl group, ethyl group, propyl group, isopropyl group, butyl group, isobutyl group, sec-butyl group, t-butyl group, pentyl group, neopentyl group, isoamyl group, hexyl group, heptyl group, octyl group, 2-ethylhexyl group, isooctyl group, nonyl group, isononyl group, decyl group, isodecyl group, undecyl group, dodecyl group, tridecyl group, tetradecyl group, pentadecyl group, hexadecyl group, heptadecyl group, octadecyl group, and so on.

Specific examples of the alkyl (meth)acrylate represented by general formula (1) include methyl (meth)acrylate, ethyl (meth)acrylate, propyl (meth)acrylate, isopropyl (meth)acrylate, butyl (meth)acrylate, isobutyl (meth)acrylate, sec-butyl (meth)acrylate, t-butyl (meth)acrylate, pentyl (meth)acrylate, neopentyl (meth)acrylate, isoamyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, and so on. These alkyl (meth)acrylates can be used singly or in combination of two or more kinds.

The number of carbon atoms in the alkyl group of the alkyl (meth)acrylate is preferably 2 to 18, or more preferably 4 to 12.

The amount of the alkyl (meth)acrylate to be added can be, for instance, 60 to 99.5 parts by weight or preferably 70 to 99 parts by weight relative to 100 parts by weight of the total amount of the monomer composition (a).

The unsaturated monomers include functional-group-containing unsaturated monomers with examples including acidic-group-containing monomers such as carboxyl-group-containing unsaturated monomers, sulfonate-group-containing unsaturated monomers, phosphate-group-containing unsaturated monomers, etc.

Examples of carboxyl-group-containing monomers include unsaturated carboxylic acids such as (meth)acrylic acid, itaconic acid, maleic acid, fumaric acid, crotonic acid, cinammic acid, etc.; monoesters of unsaturated dicarboxylic acids such as monomethyl itaconate, monobutyl itaconate, 2-acryloyloxyethyl phthalate, etc.; monoesters of unsaturated tricarboxylic acids such as 2-methacryloyloxyethyl trimellitate, etc.; monoesters of unsaturated tetracarboxylic acids such as 2-methacryloyloxyethyl pyromellitate, etc.; carboxyalkyl acrylates such as carboxyethyl acrylates (β-carboxyethyl acrylate, etc.), carboxypentyl acrylates, etc.; acrylic acid dimer, acrylic acid trimer; anhydrides of unsaturated dicarboxylic acids such as itaconic acid anhydride, maleic acid anhydride, fumaric acid anhydride, etc.; and soon.

Examples of sulfonate-group-containing unsaturated monomers include styrene sulfonate, allylsulfonate, 2-(meth)acrylamide-2-methyl propane sulfonate, (meth)acrylamide propane sulfonate, sulfopropyl (meth)acrylate, (meth)acryloxynaphthalene sulfonate, etc.

Examples of phosphate-group-containing unsaturated monomers include 2-hydroxyethylacryloyl phosphate, etc.

Examples of the functional-group-containing unsaturated monomer other than the acidic-group-containing monomers include hydroxyl-group-containing unsaturated monomers such as 2-hydroxyethyl acrylate, 2-hydroxypropyl acrylate, 4-hydroxybutyl acrylate, etc.; amide-group-containing unsaturated monomers such as (meth)acrylamide, N,N-dimethyl (meth)acrylamide, N,N-diethyl (meth)acrylamide, N-isopropyl (meth)acrylamide, N-butyl (meth)acrylamide, N-methoxymethyl (meth)acrylamide, N-methylol (meth)acrylamide, N-methylolpropane (meth)acrylamide, etc.; amino-group-containing unsaturated monomers such as aminoethyl (meth)acrylate, N,N-dimethylaminoethyl (meth)acrylate, t-butylaminoethyl (meth)acrylate, etc.; glycidyl-group-containing unsaturated monomers such as glycidyl (meth)acrylate, methylglycidyl (meth)acrylate, etc.; cyano-group-containing unsaturated monomers such as (meth)acrylonitrile, etc.; maleimide-group-containing monomers such as N-cyclohexyl maleimide, N-isopropyl maleimide, N-lauryl maleimide, N-phenyl maleimide, etc.; itaconimide-group-containing monomers such as N-methyl itaconimide, N-ethyl itaconimide, N-butyl itaconimide, N-octyl itaconimide, N-2-ethylhexylitaconimide, N-cyclohexyl itaconimide, N-lauryl itaconimide, etc.; succinimide-group-containing monomers such as N-(meth)acryloyloxymethylene succinimide, N-(meth)acryloyl-6-oxyhexamethylene succinimide, N-(meth)acryloyl-8-oxyoctamethylene succinimide, etc.; vinyl-group-containing heterocyclic compounds such as N-vinylpyrrolidone, N-(1-methylvinyl) pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, (meth)acryloylmorpholine, etc.; functional monomers such as 2-methacryloyloxyethyl isocyanate, etc.; as well as N-vinyl carboxylic acid amides, and so on.

The amount of the functional-group-containing unsaturated monomer to be added is, for instance, 0.5 to 12 parts by weight or preferably 1 to 10 parts by weight relative to 100 parts by weight of the total amount of the monomer composition (a).

Examples of other unsaturated monomers include vinylester-group-containing monomers such as vinyl acetate, etc.; unsaturated aromatic monomers such as styrene, vinyltoluene, etc.; (meth)acrylic acid alicyclic hydrocarbon ester monomers such as cyclopentyl di(meth)acrylate, isobornyl (meth)acrylate, etc.; alkoxy-group-containing unsaturated monomers such as methoxyethyl (meth)acrylate, ethoxyethyl (meth)acrylate, etc.; olefinic monomers such as ethylene, propylene, isoprene, butadiene, isobutylene, etc.; vinyl-ether-based monomers such as vinyl ether, etc.; halogen-atom-containing unsaturated monomers such as vinyl chloride, etc.; and others including acrylate-based monomers containing a heterocycle or halogen atom, such as tetrahydrofurfuryl (meth)acrylate, fluoro(meth)acrylates, etc.

The monomer composition (a) may further comprise a polyfunctional monomer. Examples of the polyfunctional monomer include (mono or poly)alkylene glycol di(meth)acrylates including (mono or poly)ethylene glycol di(meth)acrylates such as ethylene glycol di(meth)acrylate, diethylene glycol di(meth)acrylate, triethylene glycol di(meth)acrylate, trimethylolpropane tri(meth)acrylate, tetraethylene glycol di(meth)acrylate, etc., (mono or poly)propylene glycol di(meth)acrylates such as propylene glycol di(meth)acrylate, etc.; as well as (meth)acrylic acid esters of polyols such as neopentyl glycol di(meth)acrylate, 1,6-hexane-di-ol di(meth)acrylate, tetramethylolmethane tri(meth)acrylate, pentaerythritol di(meth)acrylate, trimethylolpropane tri(meth)acrylate, pentaerythritol tri(meth)acrylate, dipentaerythritol hexa(meth)acrylate, etc.; divinylbenzene; and so on. Other Examples of the polyfunctional monomer include epoxy acrylates, polyester acrylates, urethane acrylates and the like.

The monomer composition (a) may further comprise an alkoxysilyl-group-containing vinyl monomer. The alkoxysilyl-group-containing vinyl monomer includes silicone-based (meth)acrylate monomers, silicone-based vinyl monomers, and so on.

Examples of the silicone-based (meth)acrylate monomer include (meth)acryloxyalkyl-trialkoxysilanes such as (meth)acryloxymethyl-trimethoxysilane, (meth)acryloxymethyl-triethoxysilane, 2-(meth)acryloxyethyl-trimethoxysilane, 2-(meth)acryloxyethyl-triethoxysilane, 3-(meth)acryloxypropyl-trimethoxysilane, 3-(meth)acryloxypropyl-triethoxysilane, 3-(meth)acryloxypropyl-tripropoxysilane, 3-(meth)acryloxypropyl-triisopropoxysilane, 3-(meth)acryloxypropyl-tributoxysilane, etc.; (meth)acryloxyalkyl alkyl-dialkoxysilanes such as (meth)acryloxymethyl-methyldimethoxysilane, (meth)acryloxymethyl-methyldiethoxysilane, 2-(meth)acryloxyethyl-methyldimethoxysilane, 2-(meth)acryloxyethyl-methyldiethoxysilane, 3-(meth)acryloxypropyl-methyldimethoxysilane, 3-(meth)acryloxypropyl-methyldiethoxysilane, 3-(meth)acryloxypropyl-methyldipropoxysilane, 3-(meth)acryloxypropyl-methyldiisopropoxysilane, 3-(meth)acryloxypropyl-methyldibutoxysilane, 3-(meth)acryloxypropyl-ethyldimethoxysilane, 3-(meth)acryloxypropyl-ethyldiethoxysilane, 3-(meth)acryloxypropyl-ethyldipropoxysilane, 3-(meth)acryloxypropyl-ethyldiisopropoxysilane, 3-(meth)acryloxypropyl-ethyldibutoxysilane, 3-(meth)acryloxypropyl-propyldimethoxysilane, 3-(meth)acryloxypropyl-propyldiethoxysilane, etc.; and their corresponding (meth)acryloxyalkyl-dialkyl(mono)alkoxysilanes; and so on.

Examples of the silicone-based vinyl monomer include vinyltrialkoxysilanes such as vinyltrimethoxysilane, vinyltriethoxysilane, vinyltripropoxysilane, vinyltriisopropoxysilane, vinyltributoxysilane, etc.; their corresponding vinylalkyldialkoxysilanes and vinyldialkylalkoxysilanes; vinylalkyltrialkoxysilanes such as vinylmethyltrimethoxysilane, vinylmethyltriethoxysilane, vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, γ-vinylpropyltributoxysilane, etc.; and their corresponding (vinylalkyl)alkyldialkoxysilanes and (vinylalkyl)dialkyl(mono)alkoxysilanes; and so on.

By using an alkoxysilyl-group-containing vinyl monomer, alkoxysilyl groups are introduced into the polymer chains and reactions among the silyl groups allow formation of a crosslinked structure. These alkoxysilyl-group-containing vinyl monomers can be used singly or in combination, as appropriate.

The amount of these alkoxysilyl-group-containing vinyl monomers to be added is, for instance, within a range greater than 0 part by weight up to 40 parts by weight or preferably within a range greater than 0 part by weigh up to 30 parts by weight relative to 100 parts by weight of the alkyl (meth)acrylate.

The acrylic polymer (a) can be prepared by polymerizing the monomer composition (a) by a known or commonly-used polymerization method. Examples of the polymerization method for the acrylic polymer (a) include solution polymerization methods, emulsion polymerization methods, bulk polymerization methods, polymerization methods involving irradiation of active energy rays (active energy ray polymerization methods), and so on. In particular, in view of the transparency, water resistance, cost, etc., solution polymerization methods and active energy ray polymerization methods are preferable, with the solution polymerization methods being more preferable.

For the polymerization of the acrylic polymer (a), various general solvents can be used. Examples of the solvents include organic solvents including esters such as ethyl acetate, n-butyl acetate, etc.; aromatic hydrocarbons such as toluene, benzene, etc.; aliphatic hydrocarbons such as n-hexane, n-heptane, etc.; alicyclic hydrocarbons such as cyclohexane, methyl-cyclohexane, etc.; ketones such as methyl ethyl ketone, methyl isobutyl ketone, etc.; and the like. For the solvent, a single species or a combination of two or more species can be used.

For the polymerization of the acrylic polymer (a), in accordance with the type of the polymerization reaction, can be used a polymerization initiator such as thermal polymerization initiators and photopolymerization initiators (photoinitiators) and the like. For the polymerization initiator, a single species or a combination of two or more species can be used.

Examples of the thermal polymerization initiator include azo-based initiators, peroxide-based polymerization initiators (e.g. dibenzoyl peroxide, tert-butyl permalate, etc.), redox-based polymerization initiators and the like. Among these, azo-based initiators disclosed in Japanese Patent Application Publication No. 2002-69411 are especially preferable. Such azo-based initiators are preferable because decomposition products of these initiators are unlikely to remain as components to produce a thermally-evolved gas (outgas) in the acrylic polymer (a). Examples of the azo-based initiators include 2,2′-azobisisobutylonitrile (AIBN), 2,2′-azobis-2-methylbutylonitrile (AMBN), dimethyl 2,2′-azobis(2-methylpropionate), 4,4′-azobis-4-cyanovaleric acid, and the like. The amount of the azo-based initiator used is preferably 0.05 to 0.5 parts by weight or more preferably 0.1 to 0.3 parts by weight relative to 100 parts by weight of the total monomer composition (a) constituting the acrylic polymer (a).

The acrylic polymer (a) obtained as described above is contained as a primary component in the PSA layer (A), with its content being preferably 50% by weight or more, more preferably 60% by weight or more, even more preferably 70% by weight or more, or particularly preferably 80% by weight or more.

The acrylic polymer (a) has a weight average molecular weight (Mw) of, for instance, 10×10⁴ to 300×10⁴, preferably 25×10⁴ to 150×10⁴, or more preferably 50×10⁴ to 110×10⁴. With the weight average molecular weight of the acrylic polymer (a) being 10×10⁴ or larger, the cohesive strength and the heat resistance increase. On the other hand, with the weight average molecular weight of the acrylic polymer (a) being 300×10⁴ or smaller, the viscosity of its solution can be reduced.

The weight average molecular weight of the acrylic polymer (a) can be determined by gel permeation chromatography (GPC). In particular, for example, using trade name “HLC-8120GPC” (available from Tosoh Corporation) as a GPC system, measurements can be made under the following conditions:

Sample concentration: approximately 2.0 g/L (tetrahydrofuran solution)

Sample injection volume: 20 μL

Columns: trade names “TSKgel, SuperAWM-H+SuperAW4000+SuperAW2500” (available from Tosoh Corporation)

Column size: 6.0 mm I.D.×150 mm each

Eluent: tetrahydrofuran (THF)

Flow rate: 0.4 mL/min

Detector: differential refractometer (RI)

Column temperature (measurement temperature): 40° C.

The value can be determined based on standard polystyrene.

### <Active-Hydrogen-Reactive Polyfunctional Compound>

The PSA composition (a) further comprises an active-hydrogen-reactive polyfunctional compound. The active-hydrogen-reactive compound is not particularly limited as long as the compound has per molecule two or more functional groups that are capable of reacting with active hydrogen. Examples include polyfunctional isocyanate compounds, polyfunctional epoxy compounds, and so on.

The amount of the active-hydrogen-reactive polyfunctional compound contained is not particularly limited while it is preferably 0.01 to 50 parts by weight, more preferably 0.1 to 25 parts by weight, or even more preferably 1 to 15 parts by weight relative to 100 parts by weigh of the acrylic polymer (a).

Examples of polyfunctional isocyanate compounds include lower aliphatic polyisocyanates such as 1,2-ethylene diisocyanate, 1,4-butylene diisocyanate, 1,6-hexamethylene diisocyanate, etc.; alicyclic polyisocyanates such as cyclopentylene diisocyanate, cyclohexylene diisocyanate, isophorone diisocyanate, hydrogenated tolylene diisocyanate, hydrogenated xylene diisocyanate, etc.; and aromatic polyisocyanates such as 2,4-tolylene diisocyanate, 2,6-tolylene diisocyanate, 4,4′-diphenylmethane diisocyanate, xylylene diisocyanate, etc.; and so on. Among these, one species can be used solely, or two or more species can be used in combination. As the isocyanate-based crosslinking agent, for example, can also be used commercial products including an adduct of trimethylolpropane and tolylene diisocyanate (trade name “CORONATE L” available from Nippon Polyurethane Industry Co., Ltd.), an adduct of trimethylolpropane and hexamethylene diisocyanate (trade name “CORONATE HL” available from Nippon Polyurethane Industry Co., Ltd.), an adduct of trimethylolpropane and xylylene diisocyanate (trade name “TAKENATE D-110N” available from Mitsui Chemicals, Inc.), and so on.

Examples of the polyfunctional epoxy compounds include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ethers, polypropylene glycol diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, o-diglycidyl phthalate, triglycidyl tris(2-hydroxyethyl)isocyanurate, resorcinol diglycidyl ether and bisphenol-S diglycidyl ether, as well as epoxy-based resins having two or more epoxy groups per molecule. Among these, one species can be used solely, or two or more species can be used in combination. As the epoxy-based crosslinking agent, can also be used, for example, commercial products such as trade name “TETRAD-C” available from Mitsubishi Gas Chemical Company, Inc., and so on.

### <Other Components>

As far as the properties of the present invention are not impaired, the PSA composition (a) may contain, as necessary, known additives such as other crosslinking agents, crosslinking accelerating agents, silane coupling agents, tackifier resins (rosin derivatives, polyterpene resins, petroleum resins, oil-soluble phenols, etc.), anti-aging agents, fillers, colorants (pigments and dyes, etc.), UV-absorbing agents, antioxidants, chain transfer agents, plasticizers, softeners, surfactants, anti-static agents, and so on.

When forming the PSA layer (A), various general solvents can be used also. The type of such solvent is not particularly limited, and those listed as examples of the solvent usable for the solution polymerization and the like can be used.

The crosslinking agents include melamine-based crosslinking agents, peroxide-based crosslinking as well as urea-based crosslinking agents, metal alkoxide-based crosslinking agents, metal chelate-based crosslinking agents, metal salt-based crosslinking agents, carbodiimide-based crosslinking agents, oxazoline-based crosslinking agents, aziridine-based crosslinking agents, amine-based crosslinking agents, and so on. For the crosslinking agent, a single species or a combination of two or more species can be used.

### (II) PSA Layer (B)

The PSA layer (B) comprises an acrylic polymer (b) as a primary component and can be formed from a PSA composition (b) comprising the acrylic polymer (b) as an primary component. The acrylic polymer (b) is obtainable by polymerizing a monomer composition (b), and similarly to the PSA composition (a), the PSA composition (b) comprises an active-hydrogen-reactive polyfunctional compound.

The PSA layer (B) may have a composition that is the same as or different from the composition of the PSA layer (A). From the standpoint of obtaining good adhesive properties with respect to two different adherends, they preferably have different compositions. More specifically, it is preferable to use different adhesive layers that exhibit high adhesive strength to the respective adherends.

The PSA layer (B) can be constituted similarly to the PSA layer (A) within the ranges described with respect to the PSA layer (A) and fabricated by a similar method. While it is natural, the monomer composition (b), the acrylic polymer (b) and the PSA composition (b) can also be constituted within ranges described above with respect to the monomer composition (a), the acrylic polymer (a) and the PSA composition (a), and fabricated by a similar method.

### (III) Intermediate Layer (C)

The intermediate layer (C) is placed between the PSA layer (A) and the PSA layer (B), and is formed from an intermediate layer composition (c) comprising a polymer (c) obtained by polymerizing a monomer composition (c) comprising a monomer having an active hydrogen (or “active hydrogen-containing monomer” hereinafter).

The active hydrogen-containing monomer can be, for instance, a monomer having one or more functional groups selected from a group consisting of carboxyl group, hydroxyl group and amino groups, and preferably a monomer containing one or more functional groups selected from a group consisting of hydroxyl group and amino groups.

As the monomer containing a carboxyl group, can be cited the various carboxyl-group-containing unsaturated monomers listed earlier.

Examples of the monomer containing a hydroxyl group include hydroxyl-group-containing (meth)acrylic acid esters such as 2-hydroxyethyl (meth)acrylate, 3-hydroxypropyl (meth)acrylate, 4-hydroxybutyl (meth)acrylate, 6-hydroxyhexyl (meth)acrylate, hydroxyoctyl (meth)acrylate, hydroxydecyl (meth)acrylate, hydroxylauryl (meth)acrylate, (4-hydroxymethylcyclohexyl) (meth)acrylate, etc.; vinyl alcohols, allyl alcohols, and the like. Of these, a single species may be used, or two or more species may be used in combination.

Among these, as the hydroxyl-group-containing monomers, hydroxyl-group-containing (meth)acrylic acid esters are preferable while 2-hydroxyethyl acrylate and 4-hydroxybutyl acrylate are more preferable.

The monomers containing amino groups include (meth)acrylamides, allylamines and the like.

Examples of the (meth)acrylamides include (meth)acrylamide, N-alkyl (meth)acrylamides and the like.

Examples of the N-alkyl (meth)acrylamides include N-ethyl(meth)acrylamide, N-isopropyl(meth)acrylamide, N-n-butyl(meth)acrylamide, N-octylacrylamide and the like. Examples of the N-alkyl (meth)acrylamides further include amino group-containing (meth)acrylamides such as dimethylaminoethyl(meth)acrylamide, diethylaminoethyl(meth)acrylamide, dimethylaminopropyl(meth)acrylamide, etc.

Examples of the (meth)acrylamides also include various N-hydroxyalkyl (meth)acrylamides. Examples of the N-hydroxyalkyl (meth)acrylamides include N-methylol(meth)acrylamide, N-(2-hydroxyethyl)(meth)acrylamide, N-(2-hydroxypropyl)(meth)acrylamide, N-(1-hydroxypropyl)(meth)acrylamide, N-(3-hydroxypropyl)(meth)acrylamide, N-(2-hydroxybutyl)(meth)acrylamide, N-(3-hydroxybutyl)(meth)acrylamide, N-(4-hydroxybutyl)methacrylamide, N-methyl-N-2-hydroxyethyl(meth)acrylamide and the like.

Examples of the allylamines include allylamine, allyl alkylamines, allyl alokoxyamines, diallylamine, and the like.

Among the monomers containing these amino groups, one species can be used solely, or two or more species can be used in combination.

The active hydrogen-containing monomer content in the monomer composition (c) can be suitably modified according to the compositions of the PSA layers (A) and (B). For instance, it can be 0.001 to 100% by weight, preferably 0.01 to 75% by weight, more preferably 0.1 to 50% by weight, even more preferably 1 to 25% by weight, or particularly preferably 5 to 20% by weight. With the active hydrogen-containing monomer content in the monomer composition (c) being within these ranges, the interlayer adhesive strength between the intermediate layer (C) and both the PSA layers (A) and (B) further increases.

When the acrylic polymer (a) and/or the acrylic polymer (b) contain an acid group such as a carboxyl group, etc., it is preferable that the monomer composition (c) further comprises a monomer containing a primary to tertiary amino group. By this means, it is considered that the interlayer adhesive strength between the intermediate layer (C) and both the PSA layers (A) and (B) further increases due to the acid-base interactions among the polymer (c) and the acrylic polymer(s) (a) and/or (b). The term “primary to tertiary amino group” refers to “a primary amino group, a secondary amino group or a tertiary amino group”.

In this case, the primary to tertiary amino group-containing monomer content in the monomer composition (c) is not particularly limited while it is preferably 0.1 to 25% by weight, more preferably 1 to 20% by weight, or particularly preferably 5 to 15% by weight.

The primary to tertiary amino group-containing monomer is not particularly limited. Examples thereof include dialkylaminoalkyl (meth)acrylates such as N,N-diethylaminomethyl (meth)acrylate, N,N-dimethylaminomethyl (meth)acrylate, N,N-dimethylaminoethyl (meth)acrylate, N,N-dimethylaminopropyl (meth)acrylate, N,N-diethylaminoethyl (meth)acrylate, etc.; allyl dialkylamines, allyl dialkoxyamines as well as the amino-group-containing monomers listed earlier. Among these, one may be used alone, or two or more species may be used together.

Monomers other than the active hydrogen-containing monomer and the primary to tertiary amino group-containing monomer that may be contained in the monomer composition (c) include the aforementioned various monomers that can be used for polymerization of the acrylic polymers (a) and (b). It is preferable that the monomer composition (c) further comprises a primary monomer of the monomer composition (a) and a primary monomer of the monomer composition (b). It is considered that with such a constitution, the affinities of the intermediate layer (C) to the PSA layer (A) and the PSA layer (B) increase, thus its interlayer adhesive strength further increases.

The amount of the primary monomer of the monomer composition (a) contained in the monomer composition (c) is not particularly limited while it is preferably 5 to 90% by weight, more preferably 15 to 80% by weight, or particularly preferably 25 to 70% by weight.

Likewise, the amount of the primary monomer of the monomer composition (b) contained in the monomer composition (c) is not particularly limited while it is preferably 5 to 90% by weight, more preferably 15 to 80% by weight, or particularly preferably 25 to 70% by weight.

The monomer composition (c) may comprise, besides the primary monomer of the monomer composition (a) and the primary monomer of the monomer composition (b), monomers other than the primary monomer that are contained in the monomer composition (a) and monomers other than the primary monomer contained that are in the monomer composition (b). It is preferable to comprise all monomers contained in the monomer composition (a) and all monomers contained in the monomer composition (b).

It is considered that with the monomer composition (c) having such a constitution, the affinities of the intermediate layer (C) to the PSA layer (A) and the PSA layer (B) increase, thus its interlayer adhesive strength further increases.

The polymer (c) content in the intermediate layer (C) is not particularly limited while it is preferably 2 to 50% by weight, more preferably 3 to 40% by weight, or particularly preferably 4 to 30% by weight. The polymer (c) content may be 70 to 100% by weight (e.g. 80 to 100% by weight, typically 90 to 100% by weight). With it being within these ranges, the interlayer adhesive strength is considered to further increase.

It is preferable that the intermediate layer (C) further comprises a polymer (c-a) obtained by polymerizing a monomer composition (c-a) and/or a polymer (c-b) obtained by polymerizing a monomer composition (c-b).

The active hydrogen-containing monomer contents in the respective monomer compositions (c-a) and (c-b) are independently preferable to be 0.1 to 25% by weight, more preferably 1 to 20% by weight or even more preferably within a range of 5 to 15% by weight.

When the acrylic polymer (a) and/or the acrylic polymer (b) contain an acid group such as a carboxyl group, etc., it is preferable that the monomer composition (c-a) and/or the monomer composition (c-b) further comprise a primary to tertiary amino group-containing monomer described above. By this means, it is considered that the interlayer adhesive strength between the intermediate layer (C) and both the PSA layers (A) and (B) further increases due to the acid-base interactions among the acrylic polymer (a) and/or the acrylic polymer (b) and the polymer (c-a) and/or the polymer (c-b).

In this case, the primary to tertiary amino group-containing monomer contents in the respective monomer compositions (c-a) and (c-b) are independently preferable to be 0.1 to 25% by weight, more preferably 1 to 20% by weight or particularly preferably 5 to 15% by weight.

Monomers other than the active hydrogen-containing monomer and the primary to tertiary amino group-containing monomer that can be contained in the monomer composition (c-a) include the aforementioned various monomers that can be used for polymerization of the acrylic polymer (a). It is preferable to further comprise a primary monomer of the monomer composition (a).

The amount of the primary monomer of the monomer composition (a) contained in the monomer composition (c-a) is not particularly limited while it is preferably 5 to 95% by weight, more preferably 15 to 90% by weight, or particularly preferably 25 to 85% by weight.

The monomer composition (c-a) may further comprise, besides the primary monomer of the monomer composition (a), monomers other than the primary monomer that are contained in the monomer composition (a), and preferably comprise all monomers contained in the monomer composition (a).

Likewise, monomers other than the active hydrogen-containing monomer and the primary to tertiary amino group-containing monomer that can be contained in the monomer composition (c-b) include the aforementioned various monomers that can be used for polymerization of the acrylic polymer (b). It is preferable to further comprise a primary monomer of the monomer composition (b).

The amount of the primary monomer of the monomer composition (b) contained in the monomer composition (c-b) is not particularly limited while it is preferably 5 to 95% by weight, more preferably 15 to 90% by weight, or particularly preferably 25 to 85% by weight.

The monomer composition (c-b) may further comprise, besides the primary monomer of the monomer composition (b), monomers other than the primary monomer that are contained in the monomer composition (b), and preferably comprise all monomers contained in the monomer composition (b).

The respective acrylic polymer (c-a) and acrylic polymer (c-b) contents in the intermediate layer (C) are not particularly limited while they are independently preferable to be 1 to 50% by weight, more preferably 5 to 45% by weight, or particularly preferably 10 to 40% by weight.

As described above, similarly to the acrylic polymer (a), the polymer (c), the polymer (c-a) and the polymer (c-b) can be prepared by polymerizing the monomer compositions (c), (c-a) and (c-b) by a known or commonly-used polymerization method, respectively.

The polymer (c), the polymer (c-a) and the polymer (c-b) independently have a weight average molecular weight (Mw) of, for instance, 10×10⁴ to 300×10⁴, preferably 25×10⁴ to 150×10⁴, or more preferably 50×10⁴ to 110×10⁴. With the weight average molecular weights of these polymers being 10×10⁴ or larger, the cohesive strength and the heat resistance increase. On the other hand, with the weight average molecular weights of these polymers being 300×10⁴ or smaller, the viscosity of their solutions can be reduced.

Similarly to the acrylic polymer (a), the weight average molecular weights of these polymers can be measured by gel permeation chromatography (GPC) as described above.

As far as the properties of the present invention are not impaired, the intermediate layer composition (c) may contain, as necessary, known additives such as other crosslinking agents, crosslinking accelerating agents, silane coupling agents, tackifier resins (rosin derivatives, polyterpene resins, petroleum resins, oil-soluble phenols, etc.), anti-aging agents, fillers, colorants (pigments and dyes, etc.), UV-absorbing agents, antioxidants, chain transfer agents, plasticizers, softeners, surfactants, anti-static agents, and so on.

When forming the intermediate layer (C), various general solvents can be used also. The type of such solvent is not particularly limited, and those listed as examples of the solvent usable for the solution polymerization and the like can be used.

### (IV) Multi-Layered PSA Article

The multi-layered PSA article according to the present invention can be fabricated by overlaying the respective layers described above by a conventionally known method.

Although the production method for the multi-layered PSA article according to the present invention is not particularly limited, for example, a multi-layered PSA article can be fabricated to have a constitution of substrate or release liner/PSA layer (A)/intermediate layer (C)/PSA layer (B), by (i) applying (coating) the PSA composition (a) onto a substrate or a release liner and, if necessary, allowing it to dry and/or cure to form a PSA layer (A), (ii) applying (coating) the intermediate layer composition (c) onto the PSA layer (A) formed and, if necessary, allowing it to dry and/or cure to form an intermediate layer (C), and (iii) applying (coating) the PSA composition (b) onto the intermediate layer (C) formed and, if necessary, allowing it to dry and/or cure to form a PSA layer (B).

As for another method, a multi-layered PSA article can be fabricated to have a constitution of substrate or release liner/PSA layer (A)/intermediate layer (C)/PSA layer (B)/substrate or release liner, by (i) applying (coating) the PSA composition (a) onto a substrate or a release liner and, if necessary, allowing it to dry and/or cure to form a PSA layer (A), (ii) applying (coating) the PSA composition (b) onto another substrate or release liner and, if necessary, allowing it to dry and/or cure to form a PSA layer (B), (iii) applying (coating) the intermediate layer composition (c) onto each of the PSA layers (A) and (B) formed, and (iv) adhering the coated surfaces to each other to form an intermediate layer (C).

In the production method, after the multi-layered PSA article is formed as described above, it is preferable to perform an aging treatment. The aging treatment may be carried out, for instance, at a temperature range of 40° C. to 80° C. for about one to five days.

The multi-layered PSA article according to the present invention may further comprise other layers as long as the intermediate layer (C) is present between the PSA layer (A) and the PSA layer (B). For example, it may further comprise a different layer such as a primer layer, etc., between the PSA layer (B) and a substrate or a release liner, or may further comprise a different layer such as a release liner, etc., on top of the PSA layer (A) (on the surface opposite of the surface in contact with the intermediate layer (C)).

The PSA layer is not limited to the constitution of PSA layer (A)/intermediate layer (C)/PSA layer (B). For example, it may have a constitution of PSA layer (B)/intermediate layer (C)/PSA layer (A)/intermediate layer (C)/PSA layer (B), or a constitution of PSA layer (B)/intermediate layer (C)/PSA layer (A)/substrate/PSA layer (A)/intermediate layer (C)/PSA layer (B). With such constitutions, modifications can be made to the surface layers of which strong bonding to adherends is required as well as to the inner layers of which high cohesive strength is required, making the properties easily controllable.

For the application (coating) of the PSA compositions (a), (b) and the intermediate layer composition (c), a known coating method can be employed, and commonly-used coaters can be used, such as a gravure roll coater, a reverse roll coater, a kiss roll coater, a dip roll coater, a bar coater, a knife coater, a spray coater, a comma coater, a direct coater, and so on.

The thickness of the PSA layer (A) is not particularly limited while it is preferably 0.1 μm to 500 μm, more preferably 0.5 μm to 250 μm, or even more preferably 1 μm to 200 μm.

The thickness of the PSA layer (B) is not particularly limited while it is preferably 0.1 μm to 500 μm, more preferably 1 μm to 250 μm, or even more preferably 5 μm to 200 μm.

The thickness of the intermediate layer (C) is not particularly limited while it is preferably 0.001 μm to 100 μm, more preferably 0.01 μm to 50 μm, even more preferably 0.05 μm to 10 μm, particularly preferably 0.05 μm to 5 μm, or most preferably 0.05 μm to 1 μm.

The multi-layered PSA article according to the present invention can provide a multi-layered PSA article having higher interlayer adhesive strength because of the constitution described above. In particular, a multi-layered PSA article exhibiting an interlayer adhesive strength of 4.0 N/20 mm or greater can be provided.

### (V) PSA Sheet

The PSA sheet according to the present invention comprises a multi-layered PSA article described above. For instance, according to a method described above, it can be fabricated by forming the multi-layered PSA article into a sheet.

The PSA sheet according to the present invention may have a configuration of an on-substrate PSA sheet where such a PSA layer is provided on one or each face of a substrate sheet (support), or it may have a configuration of a substrate-free PSA sheet where the PSA layer is held on a release sheet (which may be a substrate sheet having a release surface). The concept of the PSA sheet referred to here encompasses those called as PSA tapes, PSA labels, PSA films, and so on.

In an on-substrate PSA sheet having a PSA layer on each face, PSA layers are provided to both faces of the substrate while these PSA layers may be formed with PSA having the same composition or with PSA having different compositions.

Although the PSA layer is typically formed in a continuous manner, it is not limited to such a form and it can be formed into, for example, a regular or random pattern of dots, stripes, and so on. The PSA sheet provided by the present invention may be in a roll or in a flat sheet. Alternatively, the PSA sheet can be processed into various other forms.

Examples of a material forming the substrate include polyolefin-based films comprising polyolefin such as polyethylenes, polypropylenes, ethylene-propylene copolymers, etc.; polyester-based films comprising polyester such as polyethylene terephthalate, etc.; plastic films comprising plastic such as polyvinyl chloride, etc.; papers such as Kraft papers, Washi papers, etc.; fabrics such as cotton fabrics, staple cloth fabrics, etc.; non-woven fabrics such as polyester non-woven fabrics, vinylon non-woven fabrics, etc.; and metal foils.

The plastic films may be non-stretched films, or stretched (uni-axially stretched or bi-axially stretched) films. The substrate surface to be provided with a PSA layer may have been given with a surface treatment such as primer coating, corona discharge treatment, and so on.

The second invention (or simply “the present invention” hereinafter until the description of Examples) is described in detail next.

The present inventors earnestly researched for a solution to the problems (problems described under the “Technical Problem”). As a result, it has been discovered that sufficient interlayer adhesion is obtained when an intermediate layer containing a polyfunctional isocyanate compound is formed between two acrylic PSA layers, whereby the present invention has been completed.

In particular, the multi-layered PSA article according to the present invention is characterized by comprising a PSA layer (A) formed from a PSA composition (a) comprising as a primary component an acrylic polymer (a) obtained by polymerizing a monomer composition (a), a PSA layer (B) formed from a PSA composition (b) comprising as a primary component an acrylic polymer (b) obtained by polymerizing a monomer composition (b), and an intermediate layer (C) placed between the PSA layer (A) and the PSA layer (B), wherein the intermediate layer (C) is formed from an intermediate layer composition (c) comprising a polyfunctional isocyanate-based compound.

In the multi-layered PSA article according to the present invention, it is preferable that the intermediate layer (C) further comprises an acrylic polymer (c) obtained by polymerizing a monomer composition (c), and the monomer composition (c) preferably comprises at least one species selected from monomers contained in the monomer composition (a) at 25% by weight or more, and at least one species selected from monomers contained in the monomer composition (b) at 25% by weight or more.

In the multi-layered PSA article according to the present invention, the monomer composition (c) preferably comprises a primary monomer of the monomer composition (a) and a primary monomer of the monomer composition (b).

In the multi-layered PSA article according to the present invention, the monomer composition (c) preferably comprises all monomers contained in the monomer composition (a) and all monomers contained in the monomer composition (b).

In the multi-layered PSA article according to the present invention, it is preferable that the intermediate layer (C) further comprises one or more species selected from a group consisting of a polymer (c-a) obtained by polymerizing a monomer composition (c-a) and a polymer (c-b) obtained by polymerizing a monomer composition (c-b), wherein the monomer composition (c-a) comprises a primary monomer of the monomer composition (a) while the monomer composition (c-b) comprises a primary monomer of the monomer composition (b).

In the multi-layered PSA article according to the present invention, it is preferable that the monomer composition (c-a) comprises all monomers contained in the monomer composition (a) while the monomer composition (c-b) comprises all monomers contained in the monomer composition (b).

In the multi-layered PSA article according to the present invention, the polymer (c-a) is an acrylic polymer (a) while the polymer (c-b) is an acrylic polymer (b).

The PSA sheet according to the present invention is characterized by comprising, as a PSA layer, a multi-layered PSA article according to the present invention described above.

The multi-layered PSA article according to the present invention has the constitution described above, thus a multi-layered PSA article having higher interlayer adhesive strength can be provided. In particular, a multi-layered PSA article capable of suppressing interlayer delamination upon removal, etc., can be provided.

### (I) Multi-Layered PSA Article

The multi-layered PSA article according to the present invention comprises a PSA layer (A) formed from a PSA composition (a) comprising as a primary component an acrylic polymer (a) obtained by polymerizing a monomer composition (a), a PSA layer (B) formed from a PSA composition (b) comprising as a primary component an acrylic polymer (b) obtained by polymerizing a monomer composition (b), and an intermediate layer (C) placed between the PSA layer (A) and the PSA layer (B), wherein the intermediate layer (C) is formed from an intermediate layer composition (c) comprising a polyfunctional isocyanate-based compound.

It is considered that according to the embodiment, the polyfunctional isocyanate compound in the intermediate layer interacts with the acrylic polymer (a) constituting the PSA layer (A) and the acrylic polymer (b) constituting the PSA layer (B), thus the interlayer adhesive strength increases. Since the embodiment can be fabricated by a polymerization method other than photopolymerization, its production is less limited.

In general, in production methods for acrylic polymers involving photopolymerization such as UV polymerization, etc., the production rate is lower than those in solvent systems and emulsion systems. Since the polymerization would not proceed unless the system is blocked from the air, air blocking is necessary prior to photoirradiation. Thus, there are limitations such as costing more due to these aspects, etc.

(I) PSA layer (A)

The PSA layer (A) can be formed from a PSA composition (a) comprising an acrylic polymer (a) as the primary component.

<Acrylic Polymer (a)>

The acrylic polymer (a) can have the same composition as the acrylic polymer (a) in the first invention, can be constituted within the ranges described with respect to the acrylic polymer (a) in the first invention, and can be fabricated (polymerized) by a similar method. While it is natural, with respect to the monomer composition (a), the same composition as the monomer composition (a) in the first invention can be used while it can be constituted within the ranges described with respect to the monomer composition (a) in the first invention and prepared by a similar method.

### <Other Components>

As far as the properties of the present invention are not impaired, the PSA composition (a) may contain, as necessary, known additives such as crosslinking agents, crosslinking accelerating agents, silane coupling agents, tackifier resins (rosin derivatives, polyterpene resins, petroleum resins, oil-soluble phenols, etc.), anti-aging agents, fillers, colorants (pigments and dyes, etc.), UV-absorbing agents, antioxidants, chain transfer agents, plasticizers, softeners, surfactants, anti-static agents, and so on.

When forming the PSA layer (A), various general solvents can be used also. The type of such solvent is not particularly limited, and those listed as examples of the solvent usable for the solution polymerization and the like can be used.

The crosslinking agents include polyfunctional isocyanate compounds, polyfunctional epoxy compounds, melamine-based crosslinking agents, peroxide-based crosslinking as well as urea-based crosslinking agents, metal alkoxide-based crosslinking agents, metal chelate-based crosslinking agents, metal salt-based crosslinking agents, carbodiimide-based crosslinking agents, oxazoline-based crosslinking agents, aziridine-based crosslinking agents, amine-based crosslinking agents, and so on. For the crosslinking agent, a single species or a combination of two or more species can be used.

The crosslinking agent content is not particularly limited while it is preferably 0.01 to 50 parts by weight, more preferably 0.1 to 25 parts by weight, or even more preferably 1 to 15 parts by weight relative to 100 parts by weight of the acrylic polymer (a).

Examples of polyfunctional isocyanate compounds include lower aliphatic polyisocyanates such as 1,2-ethylene diisocyanate, 1,4-butylene diisocyanate, 1,6-hexamethylene diisocyanate, etc.; alicyclic polyisocyanates such as cyclopentylene diisocyanate, cyclohexylene diisocyanate, isophorone diisocyanate, hydrogenated tolylene diisocyanate, hydrogenated xylene diisocyanate, etc.; and aromatic polyisocyanates such as 2,4-tolylene diisocyanate, 2,6-tolylene diisocyanate, 4,4′-diphenylmethane diisocyanate, xylylene diisocyanate, etc.; and so on. Among these, one species can be used solely, or two or more species can be used in combination. As the isocyanate-based crosslinking agent, for example, can also be used commercial products including an adduct of trimethylolpropane and tolylene diisocyanate (trade name “CORONATE L” available from Nippon Polyurethane Industry Co., Ltd.), an adduct of trimethylolpropane and hexamethylene diisocyanate (trade name “CORONATE HL” available from Nippon Polyurethane Industry Co., Ltd.), an adduct of trimethylolpropane and xylylene diisocyanate (trade name “TAKENATE D-110N” available from Mitsui Chemicals, Inc.), and so on.

Examples of the polyfunctional epoxy compounds include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ethers, polypropylene glycol diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, o-diglycidyl phthalate, triglycidyl tris(2-hydroxyethyl)isocyanurate, resorcinol diglycidyl ether and bisphenol-S diglycidyl ether; as well as epoxy-based resins having two or more epoxy groups per molecule. Among these, one species can be used solely, or two or more species can be used in combination. As the epoxy-based crosslinking agent, can also be used, for example, commercial products such as trade name “TETRAD-C” available from Mitsubishi Gas Chemical Company, Inc., and so on.

Examples of oxazoline-based crosslinking agents include those listed as examples in Japanese Patent Application Publication No. 2009-001673. In particular, it can be a compound having a main chain of an acryl structure or a styrene structure as well as an oxazoline group as a side chain of the main chain, or preferably an oxazoline-group-containing acrylic polymer having a main chain of an acryl structure and an oxazoline group as a side chain of the main chain.

Examples of an aziridine-based crosslinking agent include trimethylolpropane tris[3-(1-azyridinyl)propionate] and trimethylolpropane tris[3-(I-(2-methyl)azyridinyl propionate)].

Examples of a metal chelate-based crosslinking agent include those listed in Japanese Patent Application Publication No. 2007-063536. In particular, examples include aluminum chelate-based compounds, titanium chelate-based compounds, zinc chelate-based compounds, zirconium chelate-based compounds, iron chelate-based compounds, cobalt chelate-based compounds, nickel chelate-based compounds, tin chelate-based compounds, manganese chelate-based compounds, and chromium chelate-based compounds.

### (II) PSA Layer (B)

The PSA layer (B) can be formed from a PSA composition (b) comprising an acrylic polymer (b) as a primary component. The acrylic polymer (b) is obtainable by polymerizing a monomer composition (b), and similarly to the PSA composition (a), the PSA composition (b) comprises an acidic-group-containing monomer.

The PSA layer (B) may have a composition that is the same as or different from the composition of the PSA layer (A). From the standpoint of obtaining good adhesive properties with respect to two different adherends, they preferably have different compositions. More specifically, it is preferable to use different adhesive layers that exhibit high adhesive strength to the respective adherends.

The PSA layer (B) can be constituted similarly to the PSA layer (A) within the ranges described with respect to the PSA layer (A) and fabricated by a similar method. While it is natural, the monomer composition (b), the acrylic polymer (b) and the PSA composition (b) can also be constituted within ranges described above with respect to the monomer composition (a), the acrylic polymer (a) and the PSA composition (a), and fabricated by a similar method.

### (III) Intermediate Layer (C)

The intermediate layer (C) is placed between the PSA layer (A) and the PSA layer (B), and is formed from an intermediate layer composition (c) comprising a polyfunctional isocyanate-based compound.

As the polyfunctional isocyanate compound, can be cited the various polyfunctional isocyanate-based compounds listed earlier under “(I) PSA layer (A)”, among which the trimethylolpropane-tolylene diisocyanate adduct is preferable. Of these polyfunctional isocyanate-based compounds, one can be used alone, or two or more species can be used together.

The polyfunctional isocyanate-based compound content in the monomer composition (c) can be suitably modified in accordance with the compositions of the PSA layers (A) and (B). For example, it can be 0.001 to 100% by weight, preferably 0.01 to 80% by weight, more preferably 0.1 to 70% by weight, even more preferably 1 to 60% by weight, or particularly preferably 5 to 50% by weight. With the polyfunctional isocyanate-based compound content in the monomer composition (c) being within these ranges, the interlayer adhesive strength between the intermediate layer (C) and both the PSA layers (A) and (B) further increases.

The intermediate layer (C) preferably further comprises an acrylic polymer (c) obtained by polymerizing a monomer composition (c).

The monomer composition (c) preferably comprises at least one species selected from monomers contained in the monomer composition (a) at 25% by weight or more and at least one species selected from monomers contained in the monomer composition (b) at 25% by weight or more, more preferably comprises at least one species selected from monomers contained in the monomer composition (a) at 35% by weight or more and at least one species selected from monomers contained in the monomer composition (b) at 35% by weight or more, even more preferably comprises at least one species selected from monomers contained in the monomer composition (a) at 45% by weight or more and at least one species selected from monomers contained in the monomer composition (b) at 45% by weight or more, or particularly preferably comprises at least one species selected from monomers contained in the monomer composition (a) at 50% by weight or more and at least one species selected from monomers contained in the monomer composition (b) at 50% by weight or more.

In the monomer composition (c), the proportions of these monomers contained in the monomer composition (a) and the monomer composition (b) at the prescribed amounts or more are not particularly limited while they independently account for preferably 5 to 90% by weight, more preferably 15 to 80% by weight, or particularly preferably 25 to 70% by weight.

The monomer composition (c) preferably comprises a primary monomer of the monomer composition (a) and a primary monomer of the monomer composition (b). In this case, the amount of the primary monomer of the monomer composition (a) contained in the monomer composition (c) is not particularly limited while it is suitably 5 to 97% by weight, preferably 5 to 90% by weight, more preferably 15 to 80% by weight, or particularly preferably 25 to 70% by weight. Similarly, the amount of the primary monomer of the monomer composition (b) contained in the monomer composition (c) is not particularly limited while it is suitably about 5 to 97% by weight, preferably 5 to 90% by weight, more preferably 15 to 80% by weight, or particularly preferably 25 to 70% by weight.

The monomer composition (c) may comprise, besides the primary monomer of the monomer composition (a) and the primary monomer of the monomer composition (b), monomers other than the primary monomer that are contained in the monomer composition (a) and monomers other than the primary monomer contained that are in the monomer composition (b). It is preferable to comprise all monomers contained in the monomer composition (a) and all monomers contained in the monomer composition (b).

It is considered that with the monomer composition (c) having such a constitution, the affinities of the intermediate layer (C) to the PSA layer (A) and the PSA layer (B) increase, thus its interlayer adhesive strength further increases.

The polymer (c) content in the intermediate layer (C) is not particularly limited while it is preferably 5 to 99.999% by weight, more preferably 15 to 80% by weight, or particularly preferably 25 to 60% by weight. With it being within these ranges, the interlayer adhesive strength is considered to further increase.

It is preferable that the intermediate layer (C) further comprises a polymer (c-a) obtained by polymerizing a monomer composition (c-a) and/or a polymer (c-b) obtained by polymerizing a monomer composition (c-b).

As monomers that can be contained in the monomer composition (c-a), can be cited the aforementioned various monomers that can be used for polymerization of the acrylic polymer (a), and it is preferable to further comprise a primary monomer of the monomer composition (a).

The amount of the primary monomer of the monomer composition (a) contained in the monomer composition (c-a) is not particularly limited while it is suitably about 5 to 98% by weight, preferably 5 to 95% by weight, more preferably 15 to 90% by weight, or particularly preferably 25 to 85% by weight.

The monomer composition (c-a) may further comprise, besides the primary monomer of the monomer composition (a), monomers other than the primary monomer that are contained in the monomer composition (a), and preferably comprise all monomers contained in the monomer composition (a).

Likewise, as monomers that can be contained in the monomer composition (c-b), can be cited the aforementioned various monomers that can be used for polymerization of the acrylic polymer (b). It is preferable to further comprise a primary monomer of the monomer composition (b).

The amount of the primary monomer of the monomer composition (b) contained in the monomer composition (c-b) is not particularly limited while it is preferably 5 to 95% by weight, more preferably 15 to 90% by weight, or particularly preferably 25 to 85% by weight.

The monomer composition (c-b) may further comprise, besides the primary monomer of the monomer composition (b), monomers other than the primary monomer that are contained in the monomer composition (b), and preferably comprise all monomers contained in the monomer composition (b).

The respective acrylic polymer (c-a) and acrylic polymer (c-b) contents in the intermediate layer (C) are not particularly limited while they are independently preferable to be 1 to 50% by weight, more preferably 5 to 45% by weight, or particularly preferably 10 to 40% by weight.

As described above, similarly to the acrylic polymer (a), the polymer (c), the polymer (c-a) and the polymer (c-b) can be prepared by polymerizing the monomer compositions (c), (c-a) and (c-b) by a known or commonly-used polymerization method, respectively.

The polymer (c), the polymer (c-a) and the polymer (c-b) each independently have a weight average molecular weight (Mw) of, for instance, 10×10⁴ to 300×10⁴, preferably 25×10⁴ to 150×10⁴, or more preferably 50×10⁴ to 110×10⁴. With the weight average molecular weights of these polymers being 10×10⁴ or larger, the cohesive strength and the heat resistance increase. On the other hand, with the weight average molecular weights of these polymers being 300×10⁴ or smaller, the viscosity of their solutions can be reduced.

Similarly to the acrylic polymer (a), the weight average molecular weights of these polymers can be measured by gel permeation chromatography (GPC) as described above.

As far as the properties of the present invention are not impaired, the intermediate layer composition (c) may contain, as necessary, known additives such as other crosslinking agents, crosslinking accelerating agents, silane coupling agents, tackifier resins (rosin derivatives, polyterpene resins, petroleum resins, oil-soluble phenols, etc.), anti-aging agents, fillers, colorants (pigments and dyes, etc.), UV-absorbing agents, antioxidants, chain transfer agents, plasticizers, softeners, surfactants, anti-static agents, and so on.

When forming the intermediate layer (C), various general solvents can be used also. The type of such solvent is not particularly limited, and those listed as examples of the solvent usable for the solution polymerization and the like can be used.

### (IV) Multi-Layered PSA Article

The multi-layered PSA article according to the present invention can be fabricated by overlaying the respective layers described above by a conventionally known method.

Although the production method for the multi-layered PSA article according to the present invention is not particularly limited, for example, a multi-layered PSA article can be fabricated to have a constitution of substrate or release liner/PSA layer (A)/intermediate layer (C)/PSA layer (B), by (i) applying (coating) the PSA composition (a) onto a substrate or a release liner and, if necessary, allowing it to dry and/or cure to form a PSA layer (A), (ii) applying (coating) the intermediate layer composition (c) onto the PSA layer (A) formed and, if necessary, allowing it to dry and/or cure to form an intermediate layer (C), and (iii) applying (coating) the PSA composition (b) onto the intermediate layer (C) formed and, if necessary, allowing it to dry and/or cure to form a PSA layer (B).

As for another method, a multi-layered PSA article can be fabricated to have a constitution of substrate or release liner/PSA layer (A)/intermediate layer (C)/PSA layer (B)/substrate or release liner, by (i) applying (coating) the PSA composition (a) onto a substrate or a release liner and, if necessary, allowing it to dry and/or cure to form a PSA layer (A), (ii) applying (coating) the PSA composition (b) onto another substrate or release liner and, if necessary, allowing it to dry and/or cure to form a PSA layer (B), (iii) applying (coating) the intermediate layer composition (c) onto each of the PSA layers (A) and (B) formed, and (iv) adhering the coated surfaces to each other to form an intermediate layer (C).

In the production method, after the multi-layered PSA article is formed as described above, it is preferable to perform an aging treatment for the reaction of the polyfunctional isocyanate compound in the intermediate layer (C). The aging treatment may be carried out, for instance, at a temperature range of 40° C. to 80° C. for about one to five days.

The multi-layered PSA article according to the present invention may further comprise other layers as long as the intermediate layer (C) is present between the PSA layer (A) and the PSA layer (B). For example, it may further comprise a different layer such as a primer layer, etc., between the PSA layer (B) and a substrate or a release liner, or may further comprise a different layer such as a release liner, etc., on top of the PSA layer (A) (on the surface opposite of the surface in contact with the intermediate layer (C)).

The PSA layer is not limited to the constitution of PSA layer (A)/intermediate layer (C)/PSA layer (B). For example, it may have a constitution of PSA layer (B)/intermediate layer (C)/PSA layer (A)/intermediate layer (C)/PSA layer (B), or a constitution of PSA layer (B)/intermediate layer (C)/PSA layer (A)/substrate/PSA layer (A)/intermediate layer (C)/PSA layer (B). With such constitutions, modifications can be made to the surface layers of which strong bonding to adherends is required as well as to the inner layer of which high cohesive strength is required, making the properties easily controllable.

For the application (coating) of the PSA compositions (a), (b) and the intermediate layer composition (c), a known coating method can be employed, and commonly-used coaters can be used, such as a gravure roll coater, a reverse roll coater, a kiss roll coater, a dip roll coater, a bar coater, a knife coater, a spray coater, a comma coater, a direct coater, and so on.

The thickness of the PSA layer (A) is not particularly limited while it is preferably 0.1 μm to 500 μm, more preferably 0.5 μm to 250 μm, or even more preferably 1 μm to 200 μm.

The thickness of the PSA layer (B) is not particularly limited while it is preferably 0.1 μm to 500 μm, more preferably 1 μm to 250 μm, or even more preferably 5 μm to 200 μm.

The thickness of the intermediate layer (C) is not particularly limited while it is preferably 0.001 μm to 100 μm, more preferably 0.01 μm to 50 μm, even more preferably 0.05 μm to 10 μm, particularly preferably 0.05 μm to 5 μm, or most preferably 0.05 μm to 1 μm.

The multi-layered PSA article according to the present invention can provide a multi-layered PSA article having higher interlayer adhesive strength because of the constitution described above. In particular, a multi-layered PSA article exhibiting an interlayer adhesive strength of 3.5 N/20 mm or greater can be provided.

### (V) PSA Sheet

The PSA sheet according to the present invention may have the same constitution as the PSA sheet in the first invention. Also for the PSA layers, substrate, etc., that may constitute the PSA sheet, the same constitutions can be used as the PSA layers, substrate, etc., in the first invention. For the material to form the substrate as well, those materials described in the first invention can be used.

Matters disclosed by the present description include the following:

(1) A multi-layered PSA article comprising:

a PSA layer (A) formed from a PSA composition (a) comprising as a primary component an acrylic polymer (a) obtained by polymerizing a monomer composition (a),

a PSA layer (B) formed from a PSA composition (b) comprising as a primary component an acrylic polymer (b) obtained by polymerizing a monomer composition (b), and

an intermediate layer (C) placed between the PSA layer (A) and the PSA layer (B),

wherein the intermediate layer (C) is formed from an intermediate layer composition (c) comprising a polyfunctional isocyanate-based compound.

(2) The multi-layered PSA article according to (1) above, wherein

the intermediate layer (C) further comprises an acrylic polymer (c) obtained by polymerizing a monomer composition (c),

wherein the monomer composition (c) comprises at least one species selected from monomers contained in the monomer composition (a) at 25% by weight or more and at least one species selected from monomers contained in the monomer composition (b) at 25% by weight or more.

(3) The multi-layered PSA article according to (2) above, wherein the monomer composition (c) comprises a primary monomer of the monomer composition (a) and a primary monomer of the monomer composition (b).

(4) The multi-layered PSA article according to either (2) or (3) above, wherein the monomer composition (c) comprises all monomers contained in the monomer composition (a) and all monomers contained in the monomer composition (b).

(5) The multi-layered PSA article according to any one of (1) to (4) above,

wherein the intermediate layer (C) further comprises one or more species selected from a group consisting of a polymer (c-a) obtained by polymerizing a monomer composition (c-a) and a polymer (c-b) obtained by polymerizing a monomer composition (c-b),

wherein the monomer composition (c-a) comprises a primary monomer of the monomer composition (a), and

the monomer composition (c-b) comprises a primary monomer of the monomer composition (b).

(6) The multi-layered PSA article according to (5) above, wherein the monomer composition (c-a) comprises all monomers contained in the monomer composition (a), and the monomer composition (c-b) comprises all monomers contained in the monomer composition (b).

(7) The multi-layered PSA article according to (5), wherein the polymer (c-a) is an acrylic polymer (a), and the polymer (c-b) is an acrylic polymer (b).

(8) A PSA sheet comprising, as a PSA layer, a multi-layered PSA article according to any one of (1) to (7) above.

### EXAMPLES

The present inventions are described more specifically with Examples and Comparative Examples given below. The present inventions are not limited to the following Examples and Comparative Examples by any means. In the following description, “part(s)” and “%” are based on the weight unless otherwise specified. Example 1-1 to Example 1-35 correspond to the first invention while Example 2-1 to Example 2-14 correspond to the second invention.

### Example 1-1

### Synthesis of Acrylic Polymer (a)

To a reaction vessel equipped with a thermometer, a stirrer, a nitrogen inlet and a reflux condenser, were placed 229 parts of ethyl acetate, 0.2 part of azobisisobutylonitrile, 95 parts of n-butyl acrylate and 5 parts of acrylic acid; and solution polymerization was carried out at 60° C. to obtain an acrylic polymer solution A containing an acrylic polymer (a) at a concentration of 30% by weight. The acrylic polymer (a) had a weight average molecular weight of 75×10⁴.

### Synthesis of Acrylic Polymer (b)

To a reaction vessel equipped with a thermometer, a stirrer, a nitrogen inlet and a reflux condenser, were placed 146 parts of ethyl acetate, 0.2 part of azobisisobutylonitrile, 95 parts of 2-ethylhexyl acrylate and 5 parts of acrylic acid; and solution polymerization was carried out at 60° C. to obtain an acrylic polymer solution B containing an acrylic polymer (b) at a concentration of 40% by weight. The acrylic polymer (b) had a weight average molecular weight of 67×10⁴.

### Synthesis of Acrylic Polymer (c)

To a reaction vessel equipped with a thermometer, a stirrer, a nitrogen inlet and a reflux condenser, were placed 182 parts of ethyl acetate, 0.2 part of azobisisobutylonitrile, 45 parts of 2-ethylhexyl acrylate, 45 parts of n-butyl acrylate, 5 parts of 2-hydroxyethyl acrylate and 5 parts of acrylic acid; and solution polymerization was carried out at 60° C. to obtain an acrylic polymer solution C containing an acrylic polymer (c) at a concentration of 35% by weight. The acrylic polymer (c) had a weight average molecular weight of 69×10⁴.

### (Fabrication of PSA Tape)

An isocyanate-based crosslinking agent (trade name “CORONATE L” available from Nippon Polyurethane Industry Co., Ltd.) was added to the acrylic polymer solution A at 3 parts to 100 parts of the acrylic polymer (a) to form a PSA composition (a). The composition was applied onto 25 μm thick polyethylene terephthalate (PET) film to have 20 μm dry thickness and allowed to dry at 100° C. for two minutes to prepare a PSA layer A.

An isocyanate-based crosslinking agent (trade name “CORONATE L” available from Nippon Polyurethane Industry Co., Ltd.) was added to the acrylic polymer solution B at 3 parts to 100 parts of the acrylic polymer (b) to form a PSA composition (b). The composition was applied onto 38 μm thick polyethylene terephthalate (PET) film that had been subjected to a release treatment to have 20 μm dry thickness and allowed to dry at 100° C. for two minutes to prepare a PSA layer B.

Subsequently, the acrylic polymer solution C was diluted with ethyl acetate so that the concentration of the acrylic polymers (c) was 5% by weight based on the solid content to prepare an intermediate layer composition (c). This composition was then applied onto the PSA layers A and B prepared, respectively, to have an overall dry thickness of 0.1 μm. The coated surfaces were adhered to each other to form an intermediate layer C. The resultant was aged at 50° C. for two days for the reaction of the isocyanate-based crosslinking agent to fabricate a PSA tape.

### Examples 1-2 to 1-14, Comparative Example 1-1

Each PSA tape was fabricated in the same manner as Example 1-1 except that the species and amounts of monomers used for syntheses of the acrylic polymers (a) to (c), the amount of crosslinking agent added, and the thickness of each PSA layer were modified as shown in Tables 1 and 2.

### Example 1-15

### Synthesis of Acrylic Polymer (a)

To a reaction vessel equipped with a thermometer, a stirrer, a nitrogen inlet and a reflux condenser, were placed 229 parts of ethyl acetate, 0.2 part of azobisisobutylonitrile, 95 parts of n-butyl acrylate and 5 parts of acrylic acid; and solution polymerization was carried out at 60° C. to obtain an acrylic polymer solution A containing an acrylic polymer (a) at a concentration of 30% by weight. The acrylic polymer (a) had a weight average molecular weight of 75×10⁴.

### Synthesis of Acrylic Polymer (b)

To a reaction vessel equipped with a thermometer, a stirrer, a nitrogen inlet and a reflux condenser, were placed 146 parts of ethyl acetate, 0.2 part of azobisisobutylonitrile, 95 parts of 2-ethylhexyl acrylate and 5 parts of acrylic acid; and solution polymerization was carried out at 60° C. to obtain an acrylic polymer solution B containing an acrylic polymer (b) at a concentration of 40% by weight. The acrylic polymer (b) had a weight average molecular weight of 67×10⁴.

### Synthesis of Acrylic Polymer (c)

To a reaction vessel equipped with a thermometer, a stirrer, a nitrogen inlet and a reflux condenser, were placed 182 parts of ethyl acetate, 0.2 part of azobisisobutylonitrile, 45 parts of 2-ethylhexyl acrylate, 45 parts of n-butyl acrylate, 5 parts of 2-hydroxyethyl acrylate and 5 parts of acrylic acid; and solution polymerization was carried out at 60° C. to obtain an acrylic polymer solution C containing an acrylic polymer (c) at a concentration of 35% by weight. The acrylic polymer (c) had a weight average molecular weight of 69×10⁴.

### Synthesis of Acrylic Polymer (c-a)

To a reaction vessel equipped with a thermometer, a stirrer, a nitrogen inlet and a reflux condenser, were placed 182 parts of ethyl acetate, 0.2 part of azobisisobutylonitrile, 90 parts of n-butyl acrylate, 5 parts of 2-hydroxyethyl acrylate and 5 parts of acrylic acid; and solution polymerization was carried out at 60° C. to obtain an acrylic polymer solution C′ containing an acrylic polymer (c-a) at a concentration of 35% by weight. The acrylic polymer (c-a) had a weight average molecular weight of 72×10⁴.

### Synthesis of Acrylic Polymer (c-b)

To a reaction vessel equipped with a thermometer, a stirrer, a nitrogen inlet and a reflux condenser, were placed 182 parts of ethyl acetate, 0.2 part of azobisisobutylonitrile, 90 parts of 2-ethylhexyl acrylate, 5 parts of 2-hydroxyethyl acrylate and 5 parts of acrylic acid; and solution polymerization was carried out at 60° C. to obtain an acrylic polymer solution C″ containing an acrylic polymer (c-b) at a concentration of 35% by weight.

The acrylic polymer (c-b) had a weight average molecular weight of 68×10⁴.

### (Fabrication of PSA Tape)

An isocyanate-based crosslinking agent (trade name “CORONATE L” available from Nippon Polyurethane Industry Co., Ltd.) was added to the acrylic polymer solution A at 3 parts to 100 parts of the acrylic polymer (a) to form a PSA composition (a). The composition was applied onto 25 μm thick polyethylene terephthalate (PET) film to have 20 μm dry thickness and allowed to dry at 100° C. for two minutes to prepare a PSA layer A.

An isocyanate-based crosslinking agent (trade name “CORONATE L” available from Nippon Polyurethane Industry Co., Ltd.) was added to the acrylic polymer solution B at 3 parts to 100 parts of the acrylic polymer (b) to form a PSA composition (b). The composition was applied onto 38 μm thick polyethylene terephthalate (PET) film that had been subjected to a release treatment to have 20 μm dry thickness and allowed to dry at 100° C. for two minutes to prepare a PSA layer B.

Subsequently, the acrylic polymer solutions C, C′ and C″ were mixed at a weight ratio of 1:1:1. The mixture was diluted with ethyl acetate so that the total of the acrylic polymers (c), (c-a) and (c-b) contents based on their solid contents was 5% by weight to prepare an intermediate layer composition (c). This composition was then applied onto the PSA layers A and B prepared, respectively, to have an overall dry thickness of 0.1 μm. The coated surfaces were adhered to each other to form an intermediate layer C. The resultant was aged at 50° C. for two days for the reaction of the isocyanate-based crosslinking agent to fabricate a PSA tape.

### Examples 1-16 to 1-24

Each PSA tape was fabricated in the same manner as Example 1-15 except that the species and amounts of monomers used for syntheses of the acrylic polymers (a) to (c), (c-a) and (c-b), the amount of crosslinking agent added, and the thickness of each PSA layer were modified as shown in Tables 3 and 4.

### Examples 1-25 to 1-28

Each PSA tape was fabricated in the same manner as Example 1-1 except that the species and amounts of monomers used for syntheses of the acrylic polymers (a) to (c), the amount of crosslinking agent added, and the thickness of each PSA layer were modified as shown in Table 5.

### Example 1-29

A PSA tape was fabricated in the same manner as Example 1-23 except that a 5% by weight (solid content) aqueous solution of a polyallylamine (trade name “PAA-15C” available from Nitto Boseki Co., Ltd.) was used in place of the acrylic polymer solution C.

### Example 1-30

A PSA tape was fabricated in the same manner as Example 1-23 except that a 5% by weight (solid content) aqueous solution of a polyallylamine (trade name “PAA-03” available from Nitto Boseki Co., Ltd.) was used in place of the acrylic polymer solution C.

### Example 1-31

A PSA tape was fabricated in the same manner as Example 1-23 except that a 5% by weight (solid content) aqueous solution of a polyallylamine (trade name “PAA-1112” available from Nitto Boseki Co., Ltd.) was used in place of the acrylic polymer solution C.

### Example 1-32

A PSA tape was fabricated in the same manner as Example 1-23 except that a 5% by weight (solid content) aqueous solution of a polydiallylamine (trade name “PAS-21” available from Nitto Boseki Co., Ltd.) was used in place of the acrylic polymer solution C.

### Example 1-33

A PSA tape was fabricated in the same manner as Example 1-23 except that a 5% by weight (solid content) aqueous solution of a diallylamine acetate-sulfur dioxide copolymer (trade name “PAS-92A” available from Nitto Boseki Co., Ltd.) was used in place of the acrylic polymer solution C.

### Example 1-34

A PSA tape was fabricated in the same manner as Example 1-23 except that a 5% by weight (solid content) aqueous solution of a diallylamine hydrochloride-maleic acid copolymer (trade name “PAS-410C” available from Nitto Boseki Co., Ltd.) was used in place of the acrylic polymer solution C.

### Example 1-35

A PSA tape was fabricated in the same manner as Example 1-23 except that a 5% by weight (solid content) aqueous solution of a diallyldimethylammonium chloride-acrylamide copolymer (trade name “PAS-J-81L” available from Nitto Boseki Co., Ltd.) was used in place of the acrylic polymer solution C.

### <Test Method>

### (1) Anchoring Strength (Interlayer Adhesive Strength)

As a primer, trade name “RC-1017” available from Road Far East Inc. was spread with cloth on 38 μm polyethylene terephthalate (PET) film and left at room temperature for 30 minutes to dry. The release liner covering the PSA tape surface was removed, and the primer-coated PET film was adhered to the tape for backing. The resultant was passed through a laminator (two rolls, temperature 80° C., pressure 0.3 MPa, rotational rate 0.5 m/min, two round-trip passes) and aged overnight. This was cut to 20 mm width by 80 mm length to prepare a test piece. With double-faced tape, the primer-coated PET adhered on the surface layer was adhered to a coated plate via double-faced tape, and based on JIS Z0237, the 180° tension angle peel anchoring strength (interlayer adhesive strength) (N/20 mm-width) was measured from the non-primer-coated PET side at a tensile speed of 300 mm/min.

The measurement results of the anchoring strength (interlayer adhesive strength) of the respective PSA tapes obtained in Examples and Comparative Examples described above are shown in Tables 1 to 6.

TABLE 1

| | | | | | | | | | | Interlayer |
|---|---|---|---|---|---|---|---|---|---|---|
| | | | | | | | | C/L | | adhesive |
| | | Acrylic polymer (parts by wt.) | | | | | | (parts | Thickness | strength |
| | | n-BA | 2-EHA | i-NA | AA | 2-HEA | 4-HBA | by wt.) | (μm) | (N/20 mm) |
| Ex. 1-1 | A layer | 95 | | | 5 | | | 3 | 20 | 5.5 |
| | B layer | | 95 | | 5 | | | 3 | 20 | |
| | Int. layer | 45 | 45 | | 5 | 5 | | | 0.1 | |
| Ex. 1-2 | A layer | 97 | | | 3 | | | 3 | 5 | 6.5 |
| | B layer | | | 90 | 10 | | | 3 | 40 | |
| | Int. layer | 50 | | 35 | 5 | 10 | | | 0.2 | |
| Ex. 1-3 | A layer | 48 | 48 | | 4 | | | 3 | 10 | 6.0 |
| | B layer | | 64 | 30 | 6 | | | 3 | 30 | |
| | Int. layer | | 90 | | 5 | | 5 | | 0.1 | |
| Ex. 1-4 | A layer | 48 | 48 | | 4 | | | 3 | 10 | 6.6 |
| | B layer | | 64 | 30 | 6 | | | 3 | 30 | |
| | Int. layer | 50 | | 35 | 5 | | 10 | | 0.1 | |
| Ex. 1-5 | A layer | 48 | 48 | | 4 | | | 3 | 10 | 6.9 |
| | B layer | | 64 | 30 | 6 | | | 3 | 30 | |
| | Int. layer | 25 | 30 | 25 | 5 | | 15 | | 0.1 | |
| Ex. 1-6 | A layer | 95 | | | 5 | | | 3 | 20 | 4.3 |
| | B layer | | 95 | | 5 | | | 3 | 20 | |
| | Int. layer | 46 | 46 | | 5 | 3 | | | 0.1 | |
| Ex. 1-7 | A layer | 48 | 48 | | 4 | | | 3 | 10 | 4.5 |
| | B layer | | 64 | 30 | 6 | | | 3 | 30 | |
| | Int. layer | | 92 | | 5 | | 3 | | 0.1 | |
| Comp. | A layer | 95 | | | 5 | | | 3 | 20 | 3.7 |
| Ex. 1-1 | B layer | | 95 | | 5 | | | 3 | 20 | |
| | Int. layer | 47.5 | 47.5 | | 5 | | | | 0.1 | |

TABLE 2

| | | | | | | | | | | | | Interlayer |
|---|---|---|---|---|---|---|---|---|---|---|---|---|
| | | | | | | | | | | C/L | | adhesive |
| | | Acrylic polymer (parts by wt.) | | | | | | | | (parts | Thickness | strength |
| | | n-BA | 2-EHA | i-NA | AA | 2-HEA | 4-HBA | DMAEA | DMAPAA | by wt.) | (μm) | (N/20 mm) |
| Ex. 1-8 | A layer | 95 | | | 5 | | | | | 3 | 20 | 9.1 |
| | B layer | | 95 | | 5 | | | | | 3 | 20 | |
| | Int. layer | 42.5 | 42.5 | | | 5 | | | 10 | | 0.1 | |
| Ex. 1-9 | A layer | 97 | | | 3 | | | | | 3 | 5 | 10.0 |
| | B layer | | | 90 | 10 | | | | | 3 | 40 | |
| | Int. layer | 45 | | 40 | | 10 | | | 5 | | 0.2 | |
| Ex. 1-10 | A layer | 48 | 48 | | 4 | | | | | 3 | 10 | 12.2 |
| | B layer | | 64 | 30 | 6 | | | | | 3 | 30 | |
| | Int. layer | | 80 | | | 15 | | | 5 | | 0.1 | |
| Ex. 1-11 | A layer | 48 | 48 | | 4 | | | | | 3 | 10 | 16.6 |
| | B layer | | 64 | 30 | 6 | | | | | 3 | 30 | |
| | Int. layer | 50 | | 35 | | | 10 | 5 | | | 0.1 | |
| Ex. 1-12 | A layer | 48 | 48 | | 4 | | | | | 3 | 10 | 17.9 |
| | B layer | | 64 | 30 | 6 | | | | | 3 | 30 | |
| | Int. layer | 25 | 35 | 20 | | | 10 | 10 | | | 0.1 | |
| Ex. 1-13 | A layer | 95 | | | 5 | | | | | 3 | 20 | 5.4 |
| | B layer | | 95 | | 5 | | | | | 3 | 20 | |
| | Int. layer | 47 | 47 | | | 3 | | | 3 | | 0.1 | |
| Ex. 1-14 | A layer | 48 | 48 | | 4 | | | | | 3 | 10 | 5.1 |
| | B layer | | 64 | 30 | 6 | | | | | 3 | 30 | |
| | Int. layer | | 94 | | | | 3 | 3 | | | 0.1 | |

TABLE 3

| | | | | | | | | | | | Interlayer |
|---|---|---|---|---|---|---|---|---|---|---|---|
| | | | | | | | | | C/L | | adhesive |
| | | | Acrylic polymer (parts by wt.) | | | | | | (parts | Thickness | strength |
| | | | n-BA | 2-EHA | i-NA | AA | 2-HEA | 4-HBA | by wt.) | (μm) | (N/20 mm) |
| Ex. 1-15 | A layer | | 95 | | | 5 | | | 3 | 20 | 8.1 |
| | B layer | | | 95 | | 5 | | | 3 | 20 | |
| | Int. layer | polymer (c-a) | 90 | | | 5 | 5 | | | 0.1 | |
| | | polymer (c-b) | | 90 | | 5 | 5 | | | | |
| | | polymer (c) | 45 | 45 | | 5 | 5 | | | | |
| Ex. 1-16 | A layer | | 97 | | | 3 | | | 3 | 5 | 9.3 |
| | B layer | | | | 90 | 10 | | | 3 | 40 | |
| | Int. layer | polymer (c-a) | 87 | | | 3 | 10 | | | 0.2 | |
| | | polymer (c-b) | | | 80 | 10 | 10 | | | | |
| | | polymer (c) | 50 | | 35 | 5 | 10 | | | | |
| Ex. 1-17 | A layer | | 48 | 48 | | 4 | | | 3 | 10 | 8.6 |
| | B layer | | | 64 | 30 | 6 | | | 3 | 30 | |
| | Int. layer | polymer (c-a) | 45.5 | 45.5 | | 4 | | 5 | | 0.1 | |
| | | polymer (c-b) | | 61.5 | 27.5 | 6 | | 5 | | | |
| | | polymer (c) | | 90 | | 5 | | 5 | | | |
| Ex. 1-18 | A layer | | 48 | 48 | | 4 | | | 3 | 10 | 9.5 |
| | B layer | | | 64 | 30 | 6 | | | 3 | 30 | |
| | Int. layer | polymer (c-a) | 43 | 43 | | 4 | | 10 | | 0.1 | |
| | | polymer (c-b) | | 59 | 25 | 6 | | 10 | | | |
| | | polymer (c) | 50 | | 35 | 5 | | 10 | | | |
| Ex. 1-19 | A layer | | 48 | 48 | | 4 | | | 3 | 10 | 9.7 |
| | B layer | | | 64 | 30 | 6 | | | 3 | 30 | |
| | Int. layer | polymer (c-a) | 40.5 | 40.5 | | 4 | | 15 | | 0.1 | |
| | | polymer (c-b) | | 56.5 | 22.5 | 6 | | 15 | | | |
| | | polymer (c) | 25 | 30 | 25 | 5 | | 15 | | | |

TABLE 4

| | | | | | | | | | | | | | Interlayer |
|---|---|---|---|---|---|---|---|---|---|---|---|---|---|
| | | | | | | | | | | | C/L | | adhesive |
| | | | Acrylic polymer (parts by wt.) | | | | | | | | (parts | Thickness | strength |
| | | | n-BA | 2-EHA | i-NA | AA | 2-HEA | 4-HBA | DMAEA | DMAPAA | by wt.) | (μm) | (N/20 mm) |
| Ex. 1-20 | A layer | | 95 | | | 5 | | | | | 3 | 40 | 14.6 |
| | B layer | | | 95 | | 5 | | | | | 3 | 40 | |
| | Int. layer | polymer (c-a) | 85 | | | | 5 | | | 10 | | 0.1 | |
| | | polymer (c-b) | | 85 | | | 5 | | | 10 | | | |
| | | polymer (c) | 42.5 | 42.5 | | | 5 | | | 10 | | | |
| Ex. 1-21 | A layer | | 97 | | | 3 | | | | | 3 | 5 | 14.9 |
| | B layer | | | | 90 | 10 | | | | | 3 | 40 | |
| | Int. layer | polymer (c-a) | 85 | | | | 10 | | | 5 | | 0.2 | |
| | | polymer (c-b) | | | 85 | | 10 | | | 5 | | | |
| | | polymer (c) | 45 | | 40 | | 10 | | | 5 | | | |
| Ex. 1-22 | A layer | | 48 | 48 | | 4 | | | | | 3 | 10 | 16.4 |
| | B layer | | | 64 | 30 | 6 | | | | | 3 | 30 | |
| | Int. layer | polymer (c-a) | 40 | 40 | | | 15 | | | 5 | | 0.1 | |
| | | polymer (c-b) | | 55 | 25 | | 15 | | | 5 | | | |
| | | polymer (c) | | 80 | | | 15 | | | 5 | | | |
| Ex. 1-23 | A layer | | 48 | 48 | | 4 | | | | | 3 | 10 | 21.7 |
| | B layer | | | 64 | 30 | 6 | | | | | 3 | 30 | |
| | Int. layer | polymer (c-a) | 42.5 | 42.5 | | | | 10 | 5 | | | 0.1 | |
| | | polymer (c-b) | | 59.5 | 25.5 | | | 10 | 5 | | | | |
| | | polymer (c) | 50 | | 35 | | | 10 | 5 | | | | |
| Ex. 1-24 | A layer | | 48 | 48 | | 4 | | | | | 3 | 10 | 23.3 |
| | B layer | | | 64 | 30 | 6 | | | | | 3 | 30 | |
| | Int. layer | polymer (c-a) | 40 | 40 | | | | 10 | 10 | | | 0.1 | |
| | | polymer (c-b) | | 55 | 25 | | | 10 | 10 | | | | |
| | | polymer (c) | 25 | 35 | 20 | | | 10 | 10 | | | | |

TABLE 5

| | | | | | | | | | | Interlayer |
|---|---|---|---|---|---|---|---|---|---|---|
| | | | | | | | | C/L | | adhesive |
| | | Acrylic polymer (parts by wt.) | | | | | | (parts | Thickness | strength |
| | | n-BA | 2-EHA | AA | 4-HBA | DMAEA | DMAPAA | by wt.) | (μm) | (N/20 mm) |
| Ex. 1-25 | A layer | 95 | | 5 | | | | 3 | 5 | 8.1 |
| | B layer | | 95 | 5 | | | | 3 | 40 | |
| | Int. layer | 45 | 45 | 10 | | | | | 0.1 | |
| Ex. 1-26 | A layer | 95 | | 5 | | | | 3 | 5 | 11.2 |
| | B layer | | 95 | 5 | | | | 3 | 40 | |
| | Int. layer | 45 | 45 | | 10 | | | | 0.1 | |
| Ex. 1-27 | A layer | 95 | | 5 | | | | 3 | 5 | 20.6 |
| | B layer | | 95 | 5 | | | | 3 | 40 | |
| | Int. layer | 45 | 45 | | | | 10 | | 0.1 | |
| Ex. 1-28 | A layer | 95 | | 5 | | | | 3 | 5 | 20.7 |
| | B layer | | 95 | 5 | | | | 3 | 40 | |
| | Int. layer | 45 | 45 | | 5 | 5 | | | 0.1 | |

TABLE 6

| | Intermediate layer polymer | Interlayer adhesive strength |
|---|---|---|
| | (trade name) | (N/20 mm) |
| Ex. 1-29 | PAA-15C | 21.0 |
| Ex. 1-30 | PAA-03 | 20.0 |
| Ex. 1-31 | PAA-1112 | 10.5 |
| Ex. 1-32 | PAS-21 | 13.8 |
| Ex. 1-33 | PAS-92A | 19.0 |
| Ex. 1-34 | PAS-410C | 4.5 |
| Ex. 1-35 | PAS-J81L | 4.8 |

Abbreviations in Tables 1 to 5 represent the following:

n-BA: n-butyl acrylate
2-EHA: 2-ethylhexyl acrylate
i-NA: isononyl acrylate
AA: acrylic acid
2-HEA: 2-hydroxyethyl acrylate
4-HBA: 4-hydroxybutyl acrylate
DMAEA: dimethylaminoethyl acrylate
DMAPAA: dimethylaminopropylacrylamide
C/L: isocyanate-based crosslinking agent (trade name “CORONATE L” available from Nippon Polyurethane Industry Co., Ltd.)

### Example 2-1

### Synthesis of Acrylic Polymer (a)

To a reaction vessel equipped with a thermometer, a stirrer, a nitrogen inlet and a reflux condenser, were placed 229 parts of ethyl acetate, 0.2 part of azobisisobutylonitrile, 95 parts of n-butyl acrylate and 5 parts of acrylic acid; and solution polymerization was carried out at 60° C. to obtain an acrylic polymer solution A containing an acrylic polymer (a) at a concentration of 30% by weight. The acrylic polymer (a) had a weight average molecular weight of 75×10⁴.

### Synthesis of Acrylic Polymer (b)

To a reaction vessel equipped with a thermometer, a stirrer, a nitrogen inlet and a reflux condenser, were placed 146 parts of ethyl acetate, 0.2 part of azobisisobutylonitrile, 95 parts of 2-ethylhexyl acrylate and 5 parts of acrylic acid; and solution polymerization was carried out at 60° C. to obtain an acrylic polymer solution B containing an acrylic polymer (b) at a concentration of 40% by weight. The acrylic polymer (b) had a weight average molecular weight of 67×10⁴.

### Synthesis of Acrylic Polymer (c)

To a reaction vessel equipped with a thermometer, a stirrer, a nitrogen inlet and a reflux condenser, were placed 182 parts of ethyl acetate, 0.2 part of azobisisobutylonitrile, 47.5 parts of 2-ethylhexyl acrylate, 47.5 parts of n-butyl acrylate and 5 parts of acrylic acid; and solution polymerization was carried out at 60° C. to obtain an acrylic polymer solution C containing an acrylic polymer (c) at a concentration of 35% by weight. The acrylic polymer (c) had a weight average molecular weight of 76×10⁴.

### (Fabrication of PSA Tape)

An epoxy-based crosslinking agent (trade name “TETRAD-C” available from Mitsubishi Gas Chemical Company, Inc.) was added to the acrylic polymer solution A at 0.02 part to 100 parts of the acrylic polymer (a) to form a PSA composition A. The composition was applied onto 25 μm thick polyethylene terephthalate (PET) film to have 20 μm dry thickness and allowed to dry at 100° C. for two minutes to prepare a PSA layer A.

An epoxy-based crosslinking agent (trade name “TETRAD-C” available from Mitsubishi Gas Chemical Company, Inc.) was added to the acrylic polymer solution B at 0.02 part to 100 parts of the acrylic polymer (b) to form a PSA composition B. The composition was applied onto 38 μm thick polyethylene terephthalate (PET) film that had been subjected to a release treatment to have 20 μm dry thickness and allowed to dry at 100° C. for two minutes to prepare a PSA layer B.

An isocyanate crosslinking agent (trade name “CORONATE L” available from Nippon Polyurethane Industry Co., Ltd.) was added at 100 parts to 100 parts of the acrylic polymer (c) and the resultant was diluted with ethyl acetate to 5% by weight solid content to prepare an intermediate layer composition C. This composition was then applied onto the PSA layers A and B prepared, respectively, to have an overall dry thickness of 0.1 μm, and the coated surfaces were adhered to each other. The resultant was aged at 50° C. for two days for the reaction of the isocyanate-based crosslinking agent to fabricate a PSA tape.

### Examples 2-2 to 2-9, Comparative Example 2-1

Each PSA tape was fabricated in the same manner as Example 2-1 except that the species and amounts of monomers used for syntheses of the acrylic polymers (a) to (c), the type and amount of crosslinking agent added, and the thickness of each PSA layer were modified as shown in Table 7.

### Example 2-10

### Synthesis of Acrylic Polymer (a)

To a reaction vessel equipped with a thermometer, a stirrer, a nitrogen inlet and a reflux condenser, were placed 229 parts of ethyl acetate, 0.2 part of azobisisobutylonitrile, 95 parts of n-butyl acrylate and 5 parts of acrylic acid; and solution polymerization was carried out at 60° C. to obtain an acrylic polymer solution A containing an acrylic polymer (a) at a concentration of 30% by weight. The acrylic polymer (a) had a weight average molecular weight of 75×10⁴.

### Synthesis of Acrylic Polymer (b)

To a reaction vessel equipped with a thermometer, a stirrer, a nitrogen inlet and a reflux condenser, were placed 146 parts of ethyl acetate, 0.2 part of azobisisobutylonitrile, 95 parts of 2-ethylhexyl acrylate and 5 parts of acrylic acid; and solution polymerization was carried out at 60° C. to obtain an acrylic polymer solution B containing an acrylic polymer (b) at a concentration of 40% by weight. The acrylic polymer (b) had a weight average molecular weight of 67×10⁴.

### Synthesis of Acrylic Polymer (c)

To a reaction vessel equipped with a thermometer, a stirrer, a nitrogen inlet and a reflux condenser, were placed 182 parts of ethyl acetate, 0.2 part of azobisisobutylonitrile, 47.5 parts of 2-ethylhexyl acrylate, 47.5 parts of n-butyl acrylate and 5 parts of acrylic acid; and solution polymerization was carried out at 60° C. to obtain an acrylic polymer solution C containing an acrylic polymer (c) at a concentration of 35% by weight. The acrylic polymer (c) had a weight average molecular weight of 76×10⁴.

### (Fabrication of PSA Tape)

An epoxy-based crosslinking agent (trade name “TETRAD-C” available from Mitsubishi Gas Chemical Company, Inc.) was added to the acrylic polymer solution A at 0.02 part to 100 parts of the acrylic polymer (a) to form a PSA composition A. The composition was applied onto 25 μm thick polyethylene terephthalate (PET) film to have 20 μm dry thickness and allowed to dry at 100° C. for two minutes to prepare a PSA layer A.

An epoxy-based crosslinking agent (trade name “TETRAD-C” available from Mitsubishi Gas Chemical Company, Inc.) was added to the acrylic polymer solution B at 0.02 part to 100 parts of the acrylic polymer (b) to form a PSA composition B. The composition was applied onto 38 μm thick polyethylene terephthalate (PET) film that had been subjected to a release treatment to have 20 μm dry thickness and allowed to dry at 100° C. for two minutes to prepare a PSA layer B.

300 parts of an isocyanate crosslinking agent (trade name “CORONATE L” available from Nippon Polyurethane Industry Co., Ltd.), 100 parts of the acrylic polymer (a) and 100 parts of the acrylic polymer (b) were added to 100 parts of the acrylic polymer (c) and the resultant was diluted with ethyl acetate to 5% by weight solid content to prepare an intermediate layer composition C. This composition was then applied onto the PSA layers A and B prepared, respectively, to have an overall dry thickness of 0.1 μm, and the coated surfaces were adhered to each other. The resultant was aged at 50° C. for two days for the reaction of the isocyanate-based crosslinking agent to fabricate a PSA tape.

### Examples 2-11 to 2-14

Each PSA tape was fabricated in the same manner as Example 2-10 except that the species and amounts of monomers used for syntheses of the acrylic polymers (a) to (c), the amounts of the acrylic polymers (a) and (b) used for the intermediate layer, the type and amount of crosslinking agent added, and the thickness of each PSA layer were modified as shown in Table 8.

### <Test Method>

### (1) Anchoring Strength (Interlayer Adhesive Strength)

As a primer, trade name “RC-1017” available from Road Far East Inc. was spread with cloth on 38 μm polyethylene terephthalate (PET) film and left at room temperature for 30 minutes to dry. The release liner covering the PSA tape surface was removed, and the primer-coated PET film was adhered to the tape for backing. The resultant was passed through a laminator (two rolls, temperature 80° C., pressure 0.3 MPa, rotational rate 0.5 m/min, two round-trip passes) and aged overnight. This was cut to 20 mm width by 80 mm length to prepare a test piece. With double-faced tape, the primer-coated PET adhered on the surface layer was adhered to a coated plate via double-faced tape, and based on JIS Z0237, the peel anchoring strength (interlayer adhesive strength) (N/20 mm-width) was measured from the primer-free PET side at a tensile speed of 300 mm/min at 180° tension angle.

The measurement results of anchoring strength (interlayer adhesive strength) of the PSA tapes obtained in Examples 2-1 to 2-14 and Comparative Example 2-1 are shown in Tables 7 to 8.

TABLE 7

| | | | | | | | | | Interlayer |
|---|---|---|---|---|---|---|---|---|---|
| | | | | | | T/C | C/L | | adhesive |
| | | Acrylic polymer (parts by wt.) | | | | (parts | (parts | Thickness | strength |
| | | n-BA | 2-EHA | i-NA | AA | by wt.) | by wt.) | (μm) | (N/20 mm) |
| Ex. 2-1 | A layer | 95 | | | 5 | 0.02 | | 20 | 3.7 |
| | B layer | | 95 | | 5 | 0.02 | | 20 | |
| | Int. layer | 47.5 | 47.5 | | 5 | | 100 | 0.1 | |
| Ex. 2-2 | A layer | 97 | | | 3 | 0.02 | | 5 | 4.1 |
| | B layer | | | 90 | 10 | 0.02 | | 40 | |
| | Int. layer | 50 | | 45 | 5 | | 100 | 0.2 | |
| Ex. 2-3 | A layer | 48 | 48 | | 4 | | 3 | 10 | 3.9 |
| | B layer | | 64 | 30 | 6 | | 3 | 30 | |
| | Int. layer | | 95 | | 5 | | 200 | 0.1 | |
| Ex. 2-4 | A layer | 48 | 48 | | 4 | | 3 | 10 | 4.3 |
| | B layer | | 64 | 30 | 6 | | 3 | 30 | |
| | Int. layer | 55 | | 40 | 5 | | 200 | 0.1 | |
| Ex. 2-5 | A layer | 48 | 48 | | 4 | | 3 | 10 | 4.6 |
| | B layer | | 64 | 30 | 6 | | 3 | 30 | |
| | Int. layer | 30 | 35 | 30 | 5 | | 200 | 0.2 | |
| Ex. 2-6 | A layer | | 95 | | 5 | 0.02 | | 40 | 3.8 |
| | B layer | 95 | | | 5 | 0.02 | | 5 | |
| | Int. layer | 47.5 | 47.5 | | 5 | | 50 | 0.2 | |
| Ex. 2-7 | A layer | 95 | | | 5 | 0.02 | | 5 | 4.4 |
| | B layer | | 95 | | 5 | 0.02 | | 40 | |
| | Int. layer | 47.5 | 47.5 | | 5 | | 100 | 0.2 | |
| Ex. 2-8 | A layer | 95 | | | 5 | 0.02 | | 5 | 5.2 |
| | B layer | | 95 | | 5 | 0.02 | | 40 | |
| | Int. layer | 47.5 | 47.5 | | 5 | | 200 | 0.2 | |
| Ex. 2-9 | A layer | 95 | | | 5 | 0.02 | | 5 | 6.0 |
| | B layer | | 95 | | 5 | 0.02 | | 40 | |
| | Int. layer | | | | | | 100 | 0.2 | |
| Comp. Ex. | A layer | 95 | | | 5 | 0.02 | | 5 | 3.3 |
| 2-1 | B layer | | 95 | | 5 | 0.02 | | 40 | |
| | Int. layer | 47.5 | 47.5 | | 5 | | | 0.2 | |

TABLE 8

| | | | | | | | | | | Interlayer |
|---|---|---|---|---|---|---|---|---|---|---|
| | | | | | | | T/C | C/L | | adhesive |
| | | | Acrylic polymer (parts by wt.) | | | | (parts | (parts | Thickness | strength |
| | | | n-BA | 2-EHA | i-NA | AA | by wt.) | by wt.) | (μm) | (N/20 mm) |
| Ex 2-10 | A layer | | 95 | | | 5 | 0.02 | | 20 | 5.4 |
| | B layer | | | 95 | | 5 | 0.02 | | 20 | |
| | Int. layer | polymer (a) | 95 | | | 5 | | 300 | 0.1 | |
| | | polymer (b) | | 95 | | 5 | | | | |
| | | polymer (c) | 47.5 | 47.5 | | 5 | | | | |
| Ex. 2-11 | A layer | | 97 | | | 3 | 0.02 | | 5 | 5.7 |
| | B layer | | | | 90 | 10 | 0.02 | | 40 | |
| | Int. layer | polymer (a) | 97 | | | 3 | | 300 | 0.2 | |
| | | polymer (b) | | | 90 | 10 | | | | |
| | | polymer (c) | 50 | | 45 | 5 | | | | |
| Ex 2-12 | A layer | | 48 | 48 | | 4 | | 3 | 10 | 5.1 |
| | B layer | | | 64 | 30 | 6 | | 3 | 30 | |
| | Int. layer | polymer (a) | 48 | 48 | | 4 | | 600 | 0.1 | |
| | | polymer (b) | | 64 | 30 | 6 | | | | |
| | | polymer (c) | | 95 | | 5 | | | | |
| Ex 2-13 | A layer | | 48 | 48 | | 4 | | 3 | 10 | 5.6 |
| | B layer | | | 64 | 30 | 6 | | 3 | 30 | |
| | Int. layer | polymer (a) | 48 | 48 | | 4 | | 600 | 0.1 | |
| | | polymer (b) | | 64 | 30 | 6 | | | | |
| | | polymer (c) | 55 | | 40 | 5 | | | | |
| Ex 2-14 | A layer | | 48 | 48 | | 4 | | 3 | 10 | 5.8 |
| | B layer | | | 64 | 30 | 6 | | 3 | 30 | |
| | Int. layer | polymer (a) | 48 | 48 | | 4 | | 600 | 0.1 | |
| | | polymer (b) | | 64 | 30 | 6 | | | | |
| | | polymer (c) | 30 | 35 | 30 | 5 | | | | |

Abbreviations in Tables 7 to 8 represent the following:

n-BA: n-butyl acrylate
2-EHA: 2-ethylhexyl acrylate
i-NA: isononyl acrylate
AA: acrylic acid
T/C: epoxy-based crosslinking agent (trade name “TETRAD-C” available from Mitsubishi Gas Chemical Company, Inc.)
C/L: isocyanate-based crosslinking agent (trade name “CORONATE L” available from Nippon Polyurethane Industry Co., Ltd.)

The present invention is not limited to the respective embodiments described above and can be modified in a variety of ways within the ranges described in the claims. The technical scope of the present invention encompasses embodiments obtained by suitably combining technical means disclosed respectively in the different embodiments.

### INDUSTRIAL APPLICABILITY

The multi-layered PSA articles according to the present invention exhibit high interlayer adhesive strength and can be used preferably for various PSA sheets.

1. A multi-layered pressure-sensitive adhesive article comprising:
a pressure-sensitive adhesive layer (A) formed from a pressure-sensitive adhesive composition (a) comprising an acrylic polymer (a) as a primary component;
a pressure-sensitive adhesive layer (B) formed from a pressure-sensitive adhesive composition (b) comprising an acrylic polymer (b) as a primary component; and
an intermediate layer (C) placed between the pressure-sensitive adhesive layer (A) and the pressure-sensitive adhesive layer (B), wherein
the pressure-sensitive adhesive composition (a) and the pressure-sensitive adhesive composition (b) individually further comprise a compound having per molecule two or more functional groups that are capable of reacting with active hydrogen, and
the intermediate layer (C) is formed from an intermediate layer composition (c) comprising a polymer (c) obtained by polymerizing a monomer composition (c) comprising a monomer having an active hydrogen.

2. The multi-layered pressure-sensitive adhesive article according to claim 1, wherein the monomer having the active hydrogen comprises at least one functional group selected from the group consisting of carboxyl group, hydroxyl group and amino groups.

3. The multi-layered pressure-sensitive adhesive article according to claim, 1 wherein
the acrylic polymer (a) is obtainable by polymerizing a monomer composition (a),
the acrylic polymer (b) is obtainable by polymerizing a monomer composition (b), and
the monomer composition (c) comprises a primary monomer of the monomer composition (a) and a primary monomer of the monomer composition (b).

4. The multi-layered pressure-sensitive adhesive article according to claim 3, wherein the monomer composition (c) comprises all monomers contained in the monomer composition (a) and all monomers contained in the monomer composition (b).

5. The multi-layered pressure-sensitive adhesive article according to claim 1, wherein the compounds contained in the pressure-sensitive adhesive composition (a) and the pressure-sensitive adhesive composition (b), with the compounds having per molecule two or more functional groups that are capable of reacting with active hydrogen, are polyfunctional isocyanate compounds.

6. The multi-layered pressure-sensitive adhesive article according to claim 1, wherein the monomer having the active hydrogen is a monomer having a hydroxyl group.

7. The multi-layered pressure-sensitive adhesive article according to claim 1, wherein the monomer having the active hydrogen is a monomer having an amino group.

8. The multi-layered pressure-sensitive adhesive article according to claim 1, wherein the intermediate layer (C) further comprises at least one species selected from the group consisting of a polymer (c-a) obtained by polymerizing a monomer composition (c-a) and a polymer (c-b) obtained by polymerizing a monomer composition (c-b), wherein
the monomer composition (c-a) comprises the monomer having the active hydrogen and a primary monomer of the monomer composition (a), and
the monomer composition (c-b) comprises the monomer having the active hydrogen and a primary monomer of the monomer composition (b).

9. The multi-layered pressure-sensitive adhesive article according to claim 1, wherein
at least one species selected from the group consisting of the acrylic polymer (a) and the acrylic polymer (b) comprises an acid group, and
the polymer (c) comprises a primary to tertiary amino group.

10. The multi-layered pressure-sensitive adhesive article according to claim 8, wherein
at least one species selected from the group consisting of the acrylic polymer (a) and the acrylic polymer (b) comprises an acid group, and
at least one species selected from the group consisting of the polymer (c), the polymer (c-a) and the polymer (c-b) comprises a primary to tertiary amino group.

11. A pressure-sensitive adhesive sheet comprising, as a pressure-sensitive adhesive layer, the multi-layered pressure-sensitive adhesive article according to claim 1.

12. The multi-layered pressure-sensitive adhesive article according to claim 2, wherein
the acrylic polymer (a) is obtainable by polymerizing a monomer composition (a),
the acrylic polymer (b) is obtainable by polymerizing a monomer composition (b), and
the monomer composition (c) comprises a primary monomer of the monomer composition (a) and a primary monomer of the monomer composition (b).

13. The multi-layered pressure-sensitive adhesive article according to claim 12, wherein the monomer composition (c) comprises all monomers contained in the monomer composition (a) and all monomers contained in the monomer composition (b).

14. The multi-layered pressure-sensitive adhesive article according to claim 2, wherein the compounds contained in the pressure-sensitive adhesive composition (a) and the pressure-sensitive adhesive composition (b), with the compounds having per molecule two or more functional groups that are capable of reacting with active hydrogen, are polyfunctional isocyanate compounds.

15. The multi-layered pressure-sensitive adhesive article according to claim 2, wherein the monomer having the active hydrogen is a monomer having a hydroxyl group.

16. The multi-layered pressure-sensitive adhesive article according to claim 2, wherein the monomer having the active hydrogen is a monomer having an amino group.

17. The multi-layered pressure-sensitive adhesive article according to claim 2, wherein the intermediate layer (C) further comprises at least one species selected from the group consisting of a polymer (c-a) obtained by polymerizing a monomer composition (c-a) and a polymer (c-b) obtained by polymerizing a monomer composition (c-b), wherein
the monomer composition (c-a) comprises the monomer having the active hydrogen and a primary monomer of the monomer composition (a), and
the monomer composition (c-b) comprises the monomer having the active hydrogen and a primary monomer of the monomer composition (b).

18. The multi-layered pressure-sensitive adhesive article according to claim 2, wherein
at least one species selected from the group consisting of the acrylic polymer (a) and the acrylic polymer (b) comprises an acid group, and
the polymer (c) comprises a primary to tertiary amino group.

19. The multi-layered pressure-sensitive adhesive article according to claim 18, wherein
at least one species selected from the group consisting of the acrylic polymer (a) and the acrylic polymer (b) comprises an acid group, and
at least one species selected from the group consisting of the polymer (c), the polymer (c-a) and the polymer (c-b) comprises a primary to tertiary amino group.

20. A pressure-sensitive adhesive sheet comprising, as a pressure-sensitive adhesive layer, the multi-layered pressure-sensitive adhesive article according to claim 2.
